(19) United States
(12) Patent Application Publication
(10) Pub. No.: US 2025/0244255 A1
(43) Pub. Date: Jul. 31, 2025

(54) SCANNING OF OBJECTS

(71) Applicant: Tomra Food (Belgium) N.V., Leuven (BE)

(72) Inventors: Dirk BALTHASAR, Boppard (DE); James FRENCH, Te Miro, Cambridge (NZ)

(73) Assignee: Tomra Food (Belgium) N.V., Leuven (BE)

(21) Appl. No.: 18/856,726

(22) PCT Filed: Apr. 14, 2023
(86) PCT No.: PCT/EP2023/059806

§ 371 Date: Oct. 14, 2024

(30) Foreign Application Priority Data
Apr. 14, 2022 (WO) PCT/IB2022/053515
May 2, 2022 (WO) PCT/IB2022/054041
Apr. 4, 2023 (EP) 23166520.9

(51) Int. Cl. G01N 21/89; G01N 21/25; G01N 21/27; G01N 21/85

(52) U.S. Cl. CPC G01N 21/8901; G01N 21/255; G01N 21/27; G01N 21/85; G01N 2021/8592; G01N 2201/1047

(57) ABSTRACT

The present disclosure relates to an inspection system for inspecting objects passing through an inspection area, which inspection area is divided into a plurality of elongated inspection zones having a longitudinal extension, the inspection system comprising: at least one detector and a scanning element adapted for redirecting the detector's field of view to any one of the plurality of elongated inspection zones, wherein the scanning element is adapted to rotate around a first rotational axis and comprises at least two reflective surfaces which redirect the detector's field of view to different inspection zones of the inspection are. A method for inspecting objects passing through an inspection area by an inspection system is also disclosed.

### TECHNICAL FIELD

The inventive concept described herein generally relates to an apparatus and system for inspection of objects and a method of doing the same.

### BACKGROUND AND SUMMARY

There is a general increase and interest in automated analysis of objects. By automated analysis of objects, the objects may be classified according to a predetermined criterion and enable sorting the objects according to the predetermined criterion. Hyperspectral imaging (or hyperspectral analysis) is a common technique that enables collection and processing information from across the electromagnetic spectra when analyzing objects.

One example of a hyperspectral imaging sysem is shown in WO 2021/249698 A1, where a polygon mirror redirects the field of view of at least one detector in a direction orthogonal to transportation of said matter, so as to inspect the full width or a partial width of the stream of matter being transported on the conveyor belt. If WO 2021/249698 A1 only inspects e.g. a quarter of the stream, four identical systems can be used in parallel to cover the whole stream.

There is always an interest in increasing the accuracy of a sorting system working at high speed while simultaneously ensuring a cost-effective solution. Many times, the matter is to be sorted in at least two different directions, or to two different destinations, dependent on a predetermined set of properties, such as if the matter has eg. an acceptable amount of surface irregularities (Group I) or an non-acceptable amount of surface irregularities (Group II). The accuracy of the sorting may be increased e.g. by: increasing the accuracy of the analyzing step so fewer objects are classified as Group II when they actually belong to Group I, and vice versa; and/or by increasing the accuracy at the ejection step so that the objects are ejected in the correct direction or to the correct destination.

In view of the above, an object of the present invention is to provide a cost-effective inspection system that enables a higher sorting accuracy while preferably maintaining or increasing the throughput capability. To achieve this object, and/or other objects that will be evident from the following description, an inspection system having the features defined in claim 1 is provided according to the present invention. Preferred embodiments of the inspection system will be evident from the dependent claims.

According to a one aspect, the invention relates to an inspection system for inspecting objects passing through an inspection area, which inspection area is divided into or comprises a plurality of elongated inspection zones having a longitudinal extension. The inspection system comprises: a detector system with at least one detector and an optical arrangement for receiving optical radiation originating from an object arranged in at least one of said plurality of inspection zones and redirecting said optical radiation towards said at least one detector, and providing said at least one detector with a respective field of view;
a scanning element conDured to rotate around a first rotation axis and comprising:
a plurality of reflective surfaces arranged one after another around said first rotation axis, which plurality of reflective surfaces comprises a set of reflective surfaces, wherein each reflective surface in said set of reflective surfaces is associated with a respective one of said elongated inspection zones;
wherein the scanning element is configured, and/or adapted in size and shape, to redirect the field of view of said at least one detector to each one of said plurality of elongated inspection zones once per revolution of said scanning element, and each one of said reflective surfaces in said set of reflective surfaces are configured to redirect the field of view of said at least one detector to a respective one of said plurality of elongated inspection zones at least once per revolution of said scanning element, and
the rotational axis is arranged such that each one of said reflective surfaces in said set of reflective surfaces redirects the field of view along the longitudinal extension of the respective elongated inspection zone upon a rotation of said scanning element.

According to a first aspect, the invention relates to an inspection system for inspecting objects passing through an inspection area, which inspection area is divided into or comprises a plurality of elongated inspection zones having a longitudinal extension. The inspection system comprises:
a detector system with at least one detector and an optical arrangement for receiving optical radiation originating from an object arranged in at least one of said plurality of inspection zones and redirecting said optical radiation towards said at least one detector, and providing said at least one detector with a respective field of view;
a scanning element configured to rotate around a first rotation axis and comprising:
a plurality of reflective surfaces arranged one after another around said first rotation axis, which plurality of reflective surfaces comprises a set of reflective surfaces, wherein
wherein the scanning element or each reflective surface in said plurality of reflective surfaces is adapted in size, shape and orientation, to redirect the field of view of said at least one detector to each one of said plurality of elongated inspection zones once per revolution of said scanning element, and each one of said reflective surfaces in said set of reflective surfaces are configured to redirect the field of view of said at least one detector to and along a respective one of said plurality of elongated inspection zones once per revolution of said scanning element.

According to an alternative aspect there is provided an inspection system for inspecting objects passing through an inspection area, wherein said inspection system is configured for passing said objects through said inspection area in a main transportation direction. The inspection area is divided into a plurality of elongated inspection zones, which inspection zones preferably have a longitudinal extension. The inspection system comprises a detector system with at least one detector and an optical arrangement for receiving optical radiation originating from an object arranged in at least one of said plurality of inspection zones and redirecting said optical radiation towards said at least one detector, and providing said at least one detector with a respective field of view. The inspection system also comprises a first scanning element configured to rotate around a first rotation axis which is orthogonal or substantially orthogonal to said main transportation direction, and which scanning element comprises one reflective surface, wherein the first rotational axis is arranged such that said reflective surface of said first scanning element redirects the field of view of said at least one detector to a respective one of said plurality of elongated inspection zones upon a rotation of said first scanning element. According to this aspect the first scanning element comprises one or only one reflective surface for redirecting the field of view to the different scanning zones. According to one embodiment the scanning element is rotated back and forth between two end positions preferably associated with the two outer scanning zones. According to an alternative embodiment the scanning element is continuously rotated in the same direction, wherein the reflective surface redirects the field of view during a part of each revolution of the scanning element. The use of one reflective surface is advantageous as the element used for redirecting the field of view is less complex, compared to the scanning element described in relation to said first aspect. Optionally, the first scanning element comprises more than one reflective surface for redirecting the field of view to the respective scanning zones. Another advantage is that this solution easily allows for a large number of inspection zones, e.g. at least 30 inspection zones or at least 60 inspection zones or at least 100 inspection zones or at least 300 inspection zones or at least 500 inspection zones or at least 1000 inspections zones. The field of view may cover at least one inspection zone at a time.

According to one exemplifying embodiment, the inspection system according to the alternative aspect described above, further comprises a second scanning element configured to rotate around a second rotation axis and comprising at least one reflective surface, wherein the second rotational axis is arranged such that said reflective surface of said second scanning element redirects the field of view of said at least one detector along the longitudinal extension of the respective elongated inspection zone upon a rotation of said second scanning element. This solution is advantageous as the elements used for redirecting the field of view is less complex compared to the scanning element described in relation to said first aspect. According to one example, the second scanning element is a polygon mirror. The polygon mirror comprises a set of reflective surfaces, each reflective surface having a center surface normal, where all surface normals are preferably orthogonal to the rotation axis of the scanning element. Alternatively, the second scanning element comprises only one reflective surface for redirecting the field of view, which one reflective surface is rotated back and forth between two end positions preferably associated with the two outer scanning zones. According to an alternative embodiment the scanning element is continuously rotated in the same direction, wherein the reflective surface redirects the field of view during a part of each revolution of the scanning element.

According to one exemplifying embodiment said first and/or second scanning element is a galvanometer scanner.

The first and/or second scanning element may be tilted or rotated back and forth with the same speed in both directions. Optionally, the second scanning element may be redirected along the same inspection zone twice, once when rotated clockwise and once when rotated anti-clockwise. Alternatively, the second scanning element may be redirected along one inspection zone when being rotated clockwise, and an adjacent inspection zone when being rotated anti-clockwise. Additionally, or alternatively, first and/or second scanning element may be tilted or rotated back and forth faster in one direction compared to the other. E.g., the scanning element may be redirected more slowly in the clockwise direction to allow the detector to register the optical radiation originating from the detection zone, and be redirected significantly faster in the anti-clockwise direction as this is just used for reposition the scanning element to the start of the inspection zone without registering any spectral information.

According to one exemplifying embodiment, the inspection system is configured for passing said objects through said inspection area in a main transportation direction, and said first rotation axis is preferably orthogonal or substantially orthogonal to said main transportation direction. When passing the inspection area, the individual object may have a non-linear transport direction momentarily extending in almost any direction, while the net flow of the object stream has a main transport direction, e.g., downwards or along a free throw parabola in a free fall path, or coinciding with the transport direction of a conveyor means. This main transport direction may also be referred to as the transport direction herein.

According to an exemplifying embodiment, the rotational axis is arranged such that each reflective surface in said plurality of reflective surfaces redirects the field of view along the longitudinal extension of an associated inspection zone upon a rotation of said scanning element, which associated inspection zone may or may not coincide with, or partly overlap, an inspection zone in said plurality of elongated inspections zones.

The number of reflective surfaces in said plurality of reflective surfaces may be even or odd. Additionally, or alternatively, the number of reflective surfaces in said set of reflective surfaces may be even or odd.

According to one example, the scanning element has a first number of reflective surfaces, for example, 12 arranged one after another around said first rotation axis. In other words, there is a first number, for example, 12 reflective surfaces in said plurality of reflective surfaces. Further, there is a second number, for example, 2, 6 or 12, reflective surfaces in said set of reflective surfaces; and the same number of elongated inspection zones in said inspection region as the number of reflective surfaces in said plurality or set of reflective surfaces. Furthermore, all or a plurality or all, but a single number (such as one, two or three) of said reflective surfaces in said plurality of reflective surfaces, redirects the light to a respective one of the plurality of elongated inspections zones in said inspection area. Alternatively, all or a plurality or all, but a single number (such as one, two or three) of said reflective surfaces in said plurality of reflective surfaces, redirects the light to an elongated inspection zone that at least partly overlaps with a respective one of the plurality of elongated inspections zones in said inspection area. The scanning element may, for example, comprise a first set of reflective surfaces and a second set of reflective surfaces, where the reflective surfaces in said first and second set of reflective surfaces together constitute the plurality of reflective surfaces. The number of reflective surfaces in said first and second set of reflective surfaces may be the same or different. In other words, said plurality of reflective surface may consist of a first and a second set of reflective surfaces, wherein each reflective surface in said plurality of reflective surfaces is preferably associated with a respective one of said plurality of elongated inspection zones. When, each reflective surface in said set of reflective surfaces is associated with a respective one of said plurality of elongated inspection zones, there are two reflective surfaces associated with each elongated inspection zone. According to one example said scanning element may comprise additional reflective surfaces, in addition to said first and/or said second set of reflective surfaces.

By the scanning element being configured to redirect the field of view of said at least one detector to each one of said plurality of elongated inspection zones, the inspection area is increased compared to when the scanning element repeatedly scanning the same surface as described in WO 2021/249698 A1. Also, a higher accuracy is achieved as the reflective surfaces are arranged on the same scanning element and thereby have a fixed position relative to each other, as compared to if two separate scanning elements were to be used in parallel.

The inspection system may further be configured to enable the revolution speed of the scanning element and/or object transport speed to be adapted so that the at least one detector inspects an object to be inspected for a sufficient time to allow the at least one detector to capture image data and/or spectral data that agrees with a predetermined level of resolution and/or clarity and/or information content.

The revolution speed of the scanning element may be selected in the interval of 10-100 rpm, 100-200 rpm, 200-300 rpm, 300-400 rpm, 400-500 rpm, 500-600 rpm, 600-700 rpm, 700-800 rpm, 800-900 rpm, or 900-1000 rpm, 100-10000 rpm or more or in an interval formed by any combination of the above specified revolution speed intervals.

The object transport speed in the transporting direction through the inspection area may be selected in the interval of 0.2 m/s-20 m/s and preferably 0.4 m/s-20 m/s. The object may be transported through said inspection area in free fall or by a conveyor. If a conveyor system is present for transporting the objects, the object transport speed may be understood as a conveyor belt speed. According to one exemplifying embodiment the inspection system comprises at least one of a conveyor and a free fall path. The inspection system may comprise transportation means, which transportation means may comprise at least one of a conveyor and a free fall path.

According to one exemplifying embodiment, the inspection system comprises a conveyor and the inspection area corresponds to a surface of said conveyor. Alternatively, the inspection system further comprises a free fall path and the inspection area corresponds to said free fall path.

The objects may be provided through the inspection area in a continuous or intermittent manner. The objects may be provided through the inspection area sequentially or in parallel or as bulk flow. Hence, a single object and/or a partial object and/or a plurality of objects may be present in the inspection area at the same time. Irrespective of if the objects pass the inspection area one or several at a time, in for example, one, two or a plurality of ordered lines or in a less structured manner for example, as a bulk of matter, carried by a conveyor or in free fall, the passing objects may be referred to as a stream of objects.

The size and/or direction of extension of one, two, a set or all of the inspection zones may be selected based on for example, object types to be inspected, the expected number of objects, the size of objects, and/or the object flow rate. The size of an inspection zone may be defined by the length and the width of the inspection zone, wherein the length of the inspection zone is the distance that the field of view is redirected by the associated reflective surface during the rotation of the scanning element, and the width of this inspection zone is the extension of the field-of-view in a direction orthogonal to the length of inspection zone. In the event that the detector system has an active state where spectral information is registered from the inspection area, and an inactive state where information is not registered from the inspection area, for example, due to a shutter being closed or the detector being in an inactive state, the length and the extension of the inspection zone may correspond to the area covered by a redirection of the at least one detector's field of view assuming that the detector is in its active state during the rotation of the scanning element.

The inspection area may correspond to an area extending above or below the stream of objects or through the stream of objects or through the expected middle of the stream of objects. For example, if the passing objects is a line of bananas arranged on a flat surface such as a conveyor belt, the inspection area may coincide with the flat surface or an expected middle of these fruits although some small fruits may pass under the expected middle, or an area directly above these fruits. If the passing objects is a bulk of grains in free fall, the inspection area may extend through the expected middle of this flow of grain or within this flow of grains. The inspection area is preferably parallel with the transport direction.

The inspection area may cover or comprise the full width of the stream of objects. Alternatively, the inspection area may cover or comprise one or more portions of the full width of the stream of matter, and optionally also an area directly adjacent to the stream of objects, within which one or more portions of the at least one detector's field of view may be redirected by means of the scanning element. In more detail, the inspection area covers only a portion of the object stream path in the transporting direction of the object stream but may cover a portion or the full width of the object stream path in the lateral extension of the object stream. Irrespective of if the inspection region covers a portion or the full width of the object stream path, it may also cover a region directly adjacent to said object travel path, i.e., to the side of said object travel path. The inspection area is normally a 2D region.

According to one example when the objects pass through said inspection area, each object extends across at least 3 inspection zones simultaneously or across at least 4 inspection zones simultaneously. In relation to this inventive concept, the expression “an object extends across X inspection zones simultaneously when transported passed the inspection area” means that there is at least one point in time when the object extends across X inspection zones. Preferably, the object extends across said number of inspection zones during at least 50% of the time it takes to pass through the inspection area.

According to one exemplifying embodiments, the inspection system comprises a conveyor being one of: a conveyor belt and a conveyor being provided with a set of compartments for transporting at least one object passed said inspection area, wherein an object transporting surface of said conveyor extends over at least 3 inspection zones when said object transporting surface is arranged within said inspection area. The object transporting surface may extend over at least 60%, or over at least 75%, or over all but two, or over all, of said inspection zones, when said object transporting surface is arranged within said inspection area.

In relation to this inventive concept, the term “object transporting surface” may be understood as the surface of the conveyor being in contact with or carrying the objects during transportation.

According to one exemplifying embodiment, the objects are transported by means of a conveyor being provided with a set of compartments, each compartment having a capacity of transporting at least one object passed said inspection area; wherein said at least one object, when being transported by one of said compartments passed said inspection area, extends over at least 3 inspection zones simultaneously. Each compartment may e.g. have a capacity of transporting only one object, or at least 1 or at least 2 objects, or between 2 and 5 objects, or at least 5 or at least 10 objects, or between 2-50 objects or more than 20 or more than 50 objects of a predetermined size or type passed said inspection area. The compartment may e.g. be have the capacity of, or being designed or configured for, transporting 1 object of the size of an apple passed the inspection area; or the compartment may e.g. have the capacity of, or be designed or configured for, transporting 20 objects each of the size of a grape passed the inspection area. When the compartment has a capacity of transporting 20 grapes passed the inspection area, the 20 grapes may extend across e.g. at least 3 or 4 inspection zones simultaneously.

According to one exemplifying embodiment, when an object is passed through said inspection area, it is partially located in different inspection zones.

According to one exemple, an object and/or a conveyor surface or an object transporting conveyor surface arranged in said inspection area may each be partially located in different inspection zones.

The inspection area is generally divided into a plurality of elongated inspection zones having a longitudinal extension, which elongated inspection zones are preferably arranged side-by-side. Each elongated inspection zone of said plurality of elongated inspection zones extends in a main direction. The inspection zones may have substantially the same shape, for example, a substantially rectangular shape. The inspection zones may be arranged parallelly to each other and the respective main direction of each elongated inspection zone is for example, arranged substantially in parallel. Alternatively, all or some of the inspection zones may be arranged or in a diverging, or converging configuration in the direction of the movement of the field of view. Further, all or some of the inspection zones may be arranged or in parallel or non-parallel. The number of inspection zones may be adjusted depending on the overall size of the inspection area and how many reflective surfaces are provided by the scanning element. For instance, the number of inspection zones may be 2, 3, 4, 5, 6, 7, 8, 9, 10, at least 12, or at least 16, or at least 20 or more. The number of inspection zones may be even. The number of inspection zones may be odd. The shape of the inspection zones is dependent on geometric shapes and sizes of the reflective surfaces of the scanning element and sometimes also on the distance to the inspection area.

According to one example, the inspection area comprises two or more inspection zones that are overlapping each other, the inspection system may integrate captured data from respective zones pertaining to the same region of an object being inspected. For instance, a region A of an object may be within a first inspection zone and also within a second overlapping inspection zone. Captured data about said region A of the object may be integrated by the inspection data, thereby improving the quality of a representation provided from said captured data about said region A of the object.

Additionally, or alternatively, the inspection area comprises two or more inspection zones being directly adjacent to each other, it may be meant that they are non-overlapping. By this, the scanning element may redirect the field of view of the at least one detector along a larger, continuously extending inspection area. This may be beneficial for increasing the total field of view and/or object throughput. Additionally, or alternatively, the inspection area comprises two or more adjacent inspection zones that are arranged at a distance from each other, said inspection area enables keeping track of how an object moves and/or changes between the two separated inspection zones. This may be beneficial for motion tracking, determining object trajectories, and/or if the object otherwise changes between the two individual inspection zones. The separation distance between two adjacent inspection zones may be e.g. at least 1 mm, at least 5 mm, at least 1 cm, at least 5 cm, at least 1 dm, or at least 5 dm.

Additionally, or alternatively, the inspection area comprises a number of overlapping, directly adjacent and/or adjacent inspection zones that are arranged with substantially the same center to center distance, this may allow for the inspection to determine how individual objects move within said inspection area. It may enable the inspection system to identify whether objects are rotating or not in said inspection area and how much they are rotating. Moreover, it may enable the inspection system to identify how objects within a bulk flow move relative the bulk flow. It may also enable the inspection system to track individual objects as they move along said inspection area, e.g., determining one or more trajectories of respective one or more objects. It may also enable height measurement of objects within said inspection area and enables processing improved geometric compensation by taking height information of objects into consideration.

As an example, the reflective surfaces are oriented such that the longitudinal extensions of the elongated inspection zones are oriented substantially parallel to the object transport direction. By this, the field of view of the at least one detector may move together with objects to be inspected, thereby facilitating inspection and/or improving clarity. Alternatively, the longitudinal extensions of the elongated inspection zones are oriented substantially orthogonally to the object transport direction. By this, the field of view may move in a transverse direction of object transport path, which may be preferable to increase the number of objects that can be inspected per unit time.

According to one example, the scanning element is configured so that it is adapted for redirecting the field of view of the at least one detector along equidistant scan lines or non-equidistant scan lines.

According to one example, the longitudinal extension of each elongated inspection zone is deviating from the transport direction of the conveyor by an angle within an angular interval of 0° to ±90°, or by an angle within the angular interval of 0° to ±50°, or by an angle within the angular interval of 0° to ±25°, or by an angle within the angular interval of 0° to ±5°, or by an angle within the angular interval of 0° to ±4.4° or less°, or by an angle within the angular interval of 0° to ±2.2° or less. The deviation angle may be selected as a tradeoff between resolution of the optics and distance between the optics and the zones.

Alternatively, the longitudinal extension of each elongated inspection zone is deviating from the transport direction of the conveyor by an angle within the angular interval of ±30° to ±90°, or by an angle within the angular interval of ±40° to ±90°, or by an angle within the angular interval of ±60° to ±90°. Alternatively, the respective longitudinal extension of a majority of the elongated inspection zone is deviating from the transport direction of the conveyor by an angle within an angular interval of 0° to ±90°, or by an angle within the angular interval of 0° to ±50°, or by an angle within the angular interval of 0° to ±25°, or by an angle within the angular interval of 0° to ±5°. Alternatively, the respective longitudinal extension of a majority of the elongated inspection zone is deviating from the transport direction of the conveyor by an angle within the angular interval of ±30° to ±90°, or by an angle within the angular interval of ±40° to ±90°, or by an angle within the angular interval of ±60° to ±90°.

The inspection area may correspond to a surface of a conveyor and/or a free fall path. The inspection area may extend in a first direction and in a second direction at a right angle to the first direction. The first direction may be parallel to a transport direction of the conveyor. The second direction may be parallel to a lateral axis of the conveyor. The inspection area may be elongated in e.g., one of the first direction and the second direction.

The scanning element is configured to rotate around a first rotation axis. The scanning element may be rotatably arranged, and the first rotation axis may be arranged substantially traverse over and/or to the side of a travel path of objects to be inspected. Alternatively, the scanning element may be rotatably arranged, and the first rotation axis may be arranged substantially parallelly to, as well as above and/or to the side of, a travel path of objects to be inspected.

According to one example, the scanning element comprises a plurality of reflective surfaces preferably arranged one after another around said first rotation axis. Some, or a majority, or all of the reflective surfaces are used for inspection of the passing objects and may be referred to reflective inspection surfaces. These reflective surfaces, the reflective inspection surfaces, redirects said at least one detector's field of view to one of the inspection zones of the inspection area. Each one of the reflective inspection surfaces may redirect said at least one detector's field of view to a different elongated inspection zone, alternatively two or more of the reflective inspection surfaces may redirect said at least one detector's field of view to the same or partially the same elongated inspection zone. According to one example, for all inspection zones there are at least two reflective inspection surfaces that redirect said at least one detector's field of view to the same elongated inspection zone. In addition to the reflective inspection surfaces, the scanning element may also comprise for example, one, two or a plurality of reflective reference surfaces. The reflective reference surfaces are configured for redirecting said at least one detector's field of view to one, two or a plurality of references for calibration purposes. According to this example, the plurality of reflective surfaces comprises a plurality of reflective inspection surfaces and at least one reflective reference surface. Moreover, said plurality of reflective inspection surfaces may comprise said set of reflective surfaces. The scanning element may be adapted in shape and size so that at least two reflective surfaces in the set of reflective surfaces redirect the at least one detector's field of view to the same inspection zones of the inspection area.

The inspection system may be provided with an apparatus adapted for compiling information about objects and/or classification of objects in at least a first and a second class. The inspection system may comprise a housing for housing at least some of the components of the inspection system. The housing may be adapted to be arranged above and/or to the side of a predetermined travel path of objects to be inspected. Said travel path may be at least partly realized by means of a conveyor system.

Said apparatus may comprise an ejection arrangement provided downstream of the inspection area. The ejection arrangement may be adapted to eject and sort objects into at least two different destinations. Said at least two different destinations may depend on object classification.

Said apparatus may comprise a control cabinet. The control cabinet may include equipment for controlling the apparatus and/or the inspection system. The equipment may include a processing unit or control unit for controlling the conveyor system, the ejection arrangement, and/or the inspection system. The processing unit may be used to determine properties, or a property of the objects based on measurement carried out by the inspection system. The inspection system may comprise a control unit configured to estimate motion of the objects and/or tracking a trajectory of the objects when the objects are passing through the inspection zone. In particular, the ejection arrangement may be adapted in operable operation with the processing unit or the control unit to provide an improved ejection and sorting accuracy due to analysis and processing of the detected motion information.

According to one example, the optical radiation originating from the object is one, two or all of emitted, reflected and scattered by, and/or transmitted through, said object. The inspection system may comprise an irradiation arrangement adapted for providing an irradiation beam for irradiating the inspection zone at least partially. The inspection system may comprise at least one irradiation arrangement adapted for emitting optical radiation towards the inspection area and/or said object, preferably by said optical radiation being reflected by said scanning element. Said at least one irradiation arrangement preferably comprises an illumination/irradiation source selected from the group comprising LEDs, halogen lamps, and/or lasers. Scanning or redirecting the illumination with the same surface that scans or redirects the field of view is advantageous as it provides an improved coordination between the illumination and the field of view, compared to if the illumination was scanned with a different surface.

According to one example, said scanning element has a set of surface normals, wherein each one of said surface normals is a center surface normal of a respective one in said set of reflective surfaces and wherein each one of said surface normals in said set of surface normals has a different inclination angle to said rotation axis compared to the other surface normals in said set of surface normal. In general, the respective inclination angles may be selected within an interval of ±1°, ±2°, ±3°, ±4°, ±5°, ±6°, ±7°, ±8°, ±9°, ±10°, ±12°, ±15°, ±20°, or ±40°. The interval that the respective inclination angles may be selected within may optionally exclude ±0°, or may optionally exclude ±0.1°, or may optionally exclude ±0.4°, may optionally exclude ±1°.

Generally, the scanning element comprises at least two reflective surfaces which are angled with respectively different inclination angles. By this, a detector's field of view may be directed towards at least two different inspection zones of the inspection area. The scanning element may comprise a plurality of reflective surfaces all of which are angled with the same inclination angle. The scanning element may comprise one, two or a plurality of reflective surfaces where each reflective surface is angled by a first inclination angle to said first rotational axis. The scanning element may comprise a one, two or a plurality of reflective surfaces where each reflective surface is angled by a second inclination angle to said first rotational axis, which second inclination angle is different from said first inclination angle.

By this, the scanning element may redirect a detector's field of view to at least two different inspection zones of the inspection area. The number of inspection zones that the scanning element is capable of redirecting the detector's field of view to is for example, dependent on how many unique inclination angles are represented by the reflective surfaces of the scanning element.

According to one example, each reflective surface in said set of reflective surfaces is flat or substantially flat.

According to one example, each one of said set of reflective surfaces comprises an at least locally flat reflective surface representing a surface area of at least 80% of the whole surface area of said each one of said set of reflective surfaces. Said at least locally flat reflective surface may represent a surface area of at least 40%, or 40%-50%, 50%-60%, 60%-70%, 70%-80%, 80%-90%, or 90%-100% of the whole surface area of each reflective surface. The remaining surface, i.e., the surface that is not locally flat, curved outwards to increase the field of view and is preferably arranged at the rim portion of the reflective surface.

According to one example, all the reflective surfaces have substantially the same shape and surface area. This may facilitate the scanning element to redirect the detector's field of view to inspection zones of substantially equal shapes and optionally longitudinal extensions. Moreover, it may also result in a more mass balanced scanning element, thereby preventing wobbling thereof when the scanning element rotates about the first rotation axis. The scanning element optionally comprises an even number of flat reflective surfaces and wherein each flat reflective surface has a corresponding flat reflective surface arranged on the opposite side of said scanning element and wherein the respective surface normal of said flat reflective surface and the corresponding flat reflective surface are substantially parallel. In other words, said scanning element comprises a pair of said set of reflective surfaces, preferably arranged in an opposing arrangement. By this, if each reflective surface is also arranged at substantially identical distances from the first rotation axis, each pair of reflective surfaces provides a mass centrum that may substantially coincides with a point along the first rotation axis. Thereby, all pairs of reflective surfaces provide a mass centrum that may substantially coincide with a point along the first rotation axis. Thereby, the scanning may rotate without wobbling.

According to one example, said at least one detector system comprises at least one spectrometer for analyzing spectral characteristics of said objects. Said at least one spectrometer may be adapted to be able to cope with a required repetition rate. By repetition rate, it may mean a frequency dependent on the revolution speed of the scanning element. One or more or each spectrometer of the detector system may be configured to analyze optical radiation in the wavelength interval 100 nm-1000 nm, or optical radiation in the wavelength interval 400 nm-1100 nm or in the wavelength interval 1100 nm-1900 nm. One, two or all of the spectrometers may be adapted for analyzing visible light and/or UV-light. Additionally, or alternatively, one, two or all of the spectrometers may be adapted for analyzing NIR light. Additionally, or alternatively, one, two or all of the spectrometers may be adapted for analyzing IR light. Different types of spectrometers may be used depending on the expected characteristics of objects to be inspected. Each one of said at least one spectrometers is configured to detect electromagnetic radiation selected from the group comprising UV, visible light and NIR or a combination thereof.

According to one example, said inspection system further comprises a processing circuitry configured to execute:
a data collection function configured to collect spectral data associated with spectral characteristics of said objects based on a signal from the spectrometer, which spectral data pertains to said optical radiation originating from said objects when arranged in at least one of said first number of inspection zones,
a data processing function configured to provide an object representation based on said spectral data, and
an outputting function configured to output object information based on said object representation.

According to one example, the inspection system comprises a transportation means configured to transport the objects through the inspection area. The transportation means may be a conveyor system adapted for moving objects to be inspected along a travel path that starts, ends, or passes through the inspection area. Said travel path may additionally or alternatively involves movement sequences that involves sliding horizontally, sliding along a sloping plane, free-falling.

Said transportation means may be configured to provide a rotational movement of said objects and for example, at least a full rotation of said object. When a full rotation is provided, the detector system may establish a 360° spectral representation of the object. The full rotation of the object is provided preferably provided within the inspection area.

According to one example, said transportation means may be configured for rotating objects in a first direction around a first object rotational axis, which rotation is for example, provided by a first rotation means. Said first object rotational axis may be arranged substantially orthogonal to the object transport direction or may be arranged transverse (for example, 45 degrees) to the object transport direction.

Additionally, or alternatively, said transportation means may be configured for rotating objects in a second direction around a second object rotational axis, which second rotation is for example, provided by said first rotation means or by a second rotation means. Said second object rotational axis may be arranged substantially orthogonal to said first object rotational axis and/or said object transport direction. Additionally, or alternatively, said second object rotational axis may arranged transverse (for example 30 or 45 or 60 degrees) to the object transport direction.

According to one example, the first object rotational axis may be substantially transverse (for example 30 or 45 or 60 degrees) to the second object rotational axis.

The first and/or the second rotation means may be one or more rollers or belts which are arranged to enable said rotation of objects. Additionally, or alternatively, the first and/or the second rotation means may be a support or fixture for holding one or more objects while rotating the same. The first and/or the second rotation means may be arranged to enable said rotations within the inspection area.

By this, it may facilitate the inspection system to establish a 360° spectral representation of the object.

According to one example, said transportation means are configured to transport the objects passing through the inspection area in a direction substantially along the longitudinal extension of said first number of elongated inspection zones and wherein the first rotation axis is arranged transverse to said direction.

According to one example, the inspection system comprises a conveyor being provided with a set of compartments or supporting means, wherein each compartment or supporting means is configured for, or has a capacity of, transporting only one object, or at least 1 or at least 2 objects, or between 2 and 5 objects, or at least 5 or at least 10 objects, or between 2-50 objects or more than 20 or more than 50 objects passed said inspection area; and wherein the each compartment or supporting means is preferably arranged for rotating the objects carried by said compartment or supporting means when passing said inspection area.

According to one example, the inspection system comprises a control unit configured to estimate motion of the objects and/or tracking a trajectory of the objects when the objects are passing though the inspection zone. By this, the inspection system may readily correlate which surfaces of an object which has been inspected by the inspection system. The inspection system may thereafter estimate if an object must be rotated in any particular direction.

According to one example, each one of said at least one detectors is configured to detect electromagnetic radiation selected from the group comprising UV, visible light and NIR or a combination thereof. For example, a first detector may be adapted for analyzing UV light or mainly UV light. A second detector may be adapted for analyzing visible light or mainly visible light. A third detector may be adapted for analyzing NIR light. The inspection system may be adapted with a plurality of detectors of any one of each type of detector.

According to one example, the inspection system comprises
at least one irradiation arrangement adapted to emit optical radiation towards the inspection area and/or said object, preferably by said optical radiation being reflected by said scanning element
wherein said at least one irradiation arrangement preferably comprises an illumination source selected from the group comprising LEDs, halogen lamps and/or lasers.

By this, the inspection system may irradiate the inspection area and in particular, any one of the respective inspection zones in a controlled manner. Additionally, or alternatively, at least one illumination source is arranged such that the irradiation, after being transmitted through and/or scattered within the object, exits the object in the inspection area.

According to one example, said plurality of reflective surfaces comprises at least a first set of reflective surfaces associated with a respective at least a first set of elongated inspection zones, wherein said at least first set of elongated inspection zones comprises at least two elongated inspection zones which are overlapping, or directly adjacent or adjacent and separated by a distance.

According to one example, the number of elongated inspection zones in said inspection area is between 4 to 24, or between 8 to 12.

According to a one aspect, the invention relates to a method for inspecting objects passing through an inspection area by an inspection system, which inspection area is divided into a plurality of elongated inspection zones having a longitudinal extension, wherein said inspection system comprises a scanning element arranged to rotate around a first rotation axis and comprising a first set of reflective surfaces arranged one after another around said first rotation axis, the inspection system further comprising at least one detector having a field of view for receiving optical radiation, the method comprising:
receiving, by the at least one detector, optical radiation originating from an object arranged in at least one of said first number of inspection zones;
rotating the scanning element such that each one of said surfaces redirects the field of view of said detector to a different one of said first number of elongated inspection zones and such that each one of said surfaces redirects the field of view along the extension of the respective elongated inspection zone.

According to a second aspect, the invention relates to a method for inspecting objects passing through an inspection area by an inspection system, which inspection area is divided into a plurality of elongated inspection zones having a longitudinal extension, wherein said inspection system comprises at least one detector having a field of view for receiving optical radiation and
a scanning element arranged to rotate around a first rotation axis and comprising a first set of reflective surfaces arranged one after another around said first rotation axis, wherein each reflective surfaces is adapted in size, shape and orientation the method comprising:
receiving, by the at least one detector, optical radiation originating from an object arranged in at least one of said first number of inspection zones;
rotating the scanning element such that each one of said surfaces redirects the field of view of said detector to a different one of said first number of elongated inspection zones and such that each one of said surfaces redirects the field of view along the extension of the respective elongated inspection zone.

According to one example, the method further comprising
transporting the objects though said inspection area in a direction transverse or substantially parallel to the longitudinal extension of the inspection zones, and
rotating the objects when the objects are transported though said inspection area.

The objects may be transported by said transportation means previously discussed. The objects may be rotated by first and/or second rotation means previously discussed.

According to one example, the method comprises:
measuring spectral characteristics of the objects passing through the inspection zone.

By this, additional properties of objects rather than purely visual properties may be determined.

According to one example, the method comprises:
measuring spectral characteristics of the objects passing through the inspection zone at different sides of the objects and preferably
creating a 360° spectral representation of the object.

By this, it may be possible to establish such 360° spectral representation in a reliable manner with high throughput capability.

A spectral signature may be identified by means of spectrum processing.

According to one example, irradiation means for irradiating said objects may emit optical radiation within one or a combination of the ultraviolet, visible, near infrared and infrared wavelength range.

According to one exemplifying embodiment, said receiving of optical radiation reflected, scattered and/or emitted by said object in the first inspection zone comprises receiving optical radiation within one or a combination of the ultraviolet, visible, near infrared and infrared wavelength range.

According to one exemplifying embodiment, the sensor arrangement comprises at least a first sensor configured to detect optical radiation within the ultraviolet and/or visible wavelength range; and a second sensor configured to detect optical radiation within the near infrared and/or infrared light wavelength range.

According to one exemplifying embodiment, said scanning element and optionally optical elements are further configured to receive and redirect optical radiation from at least said second and third inspection zones towards said sensor arrangement simultaneously at least during said second and third time interval.

Said sensor arrangement preferably comprises at least one sensor array, wherein each one of said at least one sensor array has a plurality of sensor pixels, wherein said at least one sensor array is arranged such that optical radiation reflected, scattered and/or emitted by said object in a respective inspection zone is received on a respective set of sensor pixels of said at least one sensor array, wherein the pixels of said respective sets of sensor pixels are different or only partly overlapping.

The at least one detector system may comprise at least one spectrometer and/or at least one Charged Coupled Device (CCD) for analyzing spectral characteristics of said objects. Alternatively, or additionally, the at least one detector system may comprise a camera-based sensor arrangement for analysing images of said object. The camera-based sensor arrangement may for example comprise at least one 2D camera.

The inspection system may further comprise a processing unit coupled to the spectroscopy system and the camera-based sensor arrangement, wherein the processing unit being configured to determine a first property set pertaining to objects in the inspection area based on an outputted signal of the at least one detector, and wherein the processing unit being configured to optionally determine a second property set pertaining to objects in the inspection area based on an outputted signal of the at least one detector which may be a spectrometer or a camera-based sensor arrangement. The provision of a processing unit coupled to the spectroscopy system and/or the camera-based sensor arrangement brings about that the processing unit may determine properties or a property of object in the inspection area. The processing unit may thus receive signals form the spectroscopy system and/or the camera-based sensor arrangement. The received signals may be based on analysis of the light received by the spectroscopy system and/or the camera-based sensor arrangement respectively. Is should be noted that within the context of this application, the term processing unit may be any unit, system or device capable of receiving a signal or signals or data from other entities and to process the received signals or data. The processing may for instance include calculating properties or a property based on the received the received signals or data, forwarding of the received signals or data and altering the received signals or data. The processing unit may be a single unit or may be distributed over a plurality of devices, such as a plurality of PCs, each having processing capabilities. The processing unit may be implemented in hardware or in software. Is should be noted that within the context of this application, the term property set may be any set of data including any type of data. The property set may include any number of properties including 0. Hence, the property set may be an empty set, which for instance may be indicative of a non-presence of object.

The first property set may be indicative of at least one of a spectral response of the object, a material type of the object, a colour of the object, a fluorescence of the object, a phosphorescence of the object, a ripeness of the object, a dry object content of the object, a water content of the object, a fat content of the object, an oil content of the object, a calorific value of the object, a presence of bones or fishbones of the object, a presence of pest, a mineral type of the object, an ore type of the object, a defect level of the object, a detection of hazardous biological materials of the object, a presence of object, a non-presence of object, a detection of multilayer materials of the object, a detection of fluorescent and/or phosphorescence marker of the object, colour markers of the object, a quality grade of the object, a physical structure of the surface of the object, the 3D surface of the object and a molecular structure of the object.

An example of a relevant hazardous biological material that may be detected is mycotoxin.

The above features of the first property set may be determined in specific combinations which may be useful for detecting items in the inspection area. Examples of applications where such combinations are useful are sorting of pet food, detection of fishbones in fillets, paper sorting using visible and NIR spectroscopy, removal of foreign material and shells from pistachios, recycling of polymers, product rating or quality check in a packing process, to give a few non-limiting examples. The second property set may be indicative of at least one of a height of the object, a height profile of the object, a 3D map of the object, an intensity profile of reflected and/or scattered light, a volume centre of the object, an estimated mass centre of the object, an estimated weight of the object, an estimated material of the object a presence of object, a non-presence of object, a detection of isotropic and anisotropic light scattering of the object, a structure and quality of wood, a surface roughness and texture of the object and an indication of presence of fluids in the object. Examples of a relevant fluids are oil and water in food products.

Examples of applications where such combinations are useful are glass sorting and quartz sorting to give a few non-limiting examples. The processing unit may be further configured to receive an input indicative of a viewing angle of the camera-based sensor arrangement with respect to the inspection area, and to compensate for the viewing angle of the camera-based sensor arrangement when determining the second property set, which is advantageous in that a more accurate subsequent sorting or ejection of the object may be achieved. An ejector may be configured with valve image processing steps for reducing or minimizing the compressed air consumption and energy consumption while keeping optimal sorting yield and sorting loss.

The object(s) to be classified may be provided as a stream of object, and the inspection system irradiates the object, which is to be classified with optical radiation, for example, within the UV wavelength range, designed to cause a fluorescence event and/or phosphorous response from the irradiated object. As the stream of objects is moving and there is a delay until the phosphorescence occurs, it is difficult to determine the spectrum, not least the rise and decay time, with high precision.

According to one exemplifying embodiment, data from said inspection zones is collected during one or several scans by said scanning element, and this data is a representation of at least a first spectrum, and wherein classifying said objects comprises determining a wavelength distribution of the first spectrum and optionally determining at least one property relating to the shape of said first spectrum, such as the peak height, peak width and/or peak area for one or more peaks.

According to one exemplifying embodiment the classifying of said object(s) comprises determining a raise time and/or a decay time of one or both of the phosphorescence event and the fluorescent event to for example, determine the type of object.

According to one exemplifying embodiment, the classifying of said objects may comprise classifying said objects based on at least one property relating to a respective one of the color, the transmission, the reflectivity, phosphorous response and the fluorescence of said object. The properties may for example., be compared to one, two or all of a threshold, a look up table, and a reference.

According to one exemplifying embodiment, the classifying comprises: determining by means of at least one of image processing and spectrum processing whether said object(s) is provided with a phosphorus marker; and/or identifying one or a plurality of materials making up said object e.g. by means of spectrum processing; and/or upon determining a plurality of materials making up one piece of object, determining if the combination of these materials is acceptable or non-acceptable.

The phosphorus marker may for example, be identified based on its shape, which profile may be identified by image processing. Additionally, or alternatively, the phosphorus marker may for example, be identified based on its spectrum or spectral signature emitted in response to being illuminated.

According to one example, the inspection system may be calibrated by placing a target calibration arrangement in the inspection area, wherein said target calibration arrangement is adapted in size and shape to provide a calibration surface provided with a geometric shape and/or pattern. The inspection system may be configured to inspect the target calibration arrangement to calibrate itself in terms of detector settings. Detector settings may include setting a focal point of the at least one detector, calibration of the acquisition geometry, setting color settings, allocating bins of a spectrometer to different wavelength, allocating each detection zone with a set of pixels. The calibration surface may provide a textured surface. A textured surface may reduce the occurrence of specular reflection from being detected by the at least one detector.

Additionally, or alternatively, the inspection system may comprise one, two or more spectral calibration zones for enabling repeated calibration of the spectral data of the inspection system, which at least one spectral calibration zone is/are preferably arranged downstream of the scanning element and optionally upstream of the inspection area as seen in the direction of the irradiating illumination. Preferably, the repeated calibration is performed once per reflective surface of said scanning element, or at least a plurality of times per revolution of said scanning element.

In particular, one advantage of the present inventive concept is that it enables a solution with a scanning internal illumination, and thereby provides a higher energy efficiency compared to a solution with an external illumination, since an internal illumination requires order of magnitude less energy.

### BRIEF DESCRIPTION OF THE DRAWINGS

The above, as well as additional objects, features and advantages of the present inventive concept, will be better understood through the following illustrative and non-limiting detailed description, with reference to the appended drawings. In the drawings like reference numerals will be used for like elements unless stated otherwise.

FIG. 1 shows a schematic view of an apparatus comprising an inspection system according to one embodiment of the invention;

FIGS. 2a-2b schematically illustrate two respective orientations of the inspection area relative a conveyor system;

FIG. 3 schematically illustrates some components of the inspection system according to one embodiment of the invention;

FIG. 4 schematically illustrates some components of the inspection system according to one embodiment of the invention;

FIG. 5 schematically illustrates some components of the inspection system according to one embodiment of the invention;

FIG. 6 schematically illustrates a scanning element of the inspection system according to one embodiment of the invention;

FIG. 7 schematically illustrates a scanning element of the inspection system according to one embodiment of the invention;

FIG. 8a-8c schematically illustrate the inspection system according to one embodiment of the invention;

FIG. 8d schematically illustrate an inspection area divided into a plurality of elongated inspection zones;

FIG. 9a shows a set of inspection images captured by the inspection system according to one embodiment;

FIG. 9b shows an ordered set of inspection images captured by the inspection system according to one embodiment;

FIGS. 10a-10c illustrate how a reflective surface of the scanning element can be adjusted in terms of inclination angle;

FIG. 11 illustrate the inspection system according to one embodiment of the invention;

FIGS. 12a-12c illustrate an aspect of speed matching of the inspection system according to one embodiment of the invention;

FIG. 13 shows a flow chart of a method according to one embodiment of the invention;

FIG. 14a show fruits carried in separate compartments by a conveyor;

FIG. 14b show one representation of the output from spectral and/or image processing of data collected when the objects shown in FIG. 14a passed through the inspection area;

FIG. 15 illustrates the difference in spectral distribution for the different fruits shown in FIG. 14a;

FIGS. 16a, 16b illustrate a target calibration arrangement according to one embodiment of the invention;

FIGS. 17a, 17b, 17c show different structures for keeping the passing objects separated and/or in different lanes when e.g. passing the inspection area.

FIG. 17d show an inspection system having a conveyor provided with a structure which separates the object stream into separate lanes;

FIGS. 18a, 18b show a side view and a top view of the same inspection system, having a polygon mirror and one rotatable reflective surfaces for redirecting the field of view;

FIG. 19a, 19b show a side view and a top view of the same inspection system, having two separate rotatable reflective surfaces for redirecting the field of view;

FIG. 20a, 20b show a side view and a top view of the same inspection system, having only one rotatable reflective surface for redirecting the field of view.

### DETAILED DESCRIPTION

The present inventive concept will now be described more fully hereinafter with reference to the accompanying drawings, in which currently preferred variants of the inventive concept are shown. This inventive concept may, however, be implemented in many different forms and should not be construed as limited to the variants set forth herein; rather, these variants are provided for thoroughness and completeness, and fully convey the scope of the present inventive concept to the skilled person.

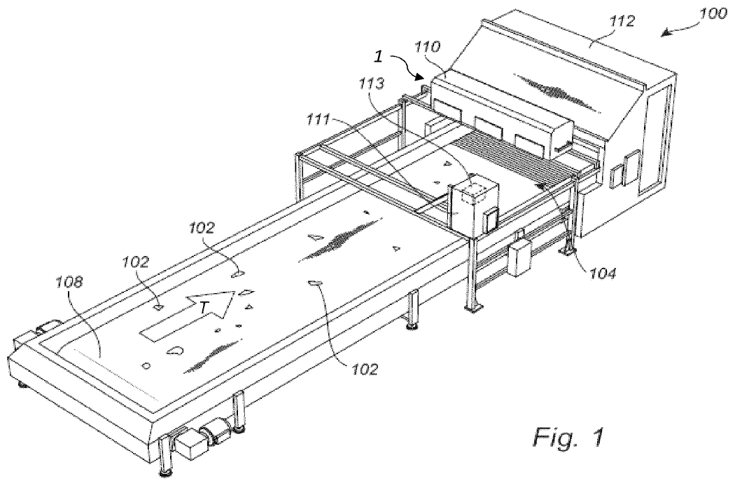

FIG. 1 shows a schematic view of an apparatus or sorting system 100 provided with an inspection system 1 according to one embodiment of the invention. The apparatus or sorting system 100 is adapted for compiling information about objects 102 and/or for classification of objects 102 in at least a first and a second class.

The inspection system 1 is adapted for inspecting objects 102 within an inspection area 104. The inspection system 1 may be adapted for inspecting objects 102 within the inspection area 104 either when said objects 102 are stationary or moving. In a preferred embodiment, the inspection system 1 is adapted for inspecting objects 102 within the inspection area 104 when said objects 102 are continuously moving. In a preferred embodiment, the inspection system 1 is adapted for inspecting objects 102 within the inspection area 104 when said objects 102 are rotating. Objects 102 to be inspected may be moving along a predetermined travel path that starts, ends, or passes through the inspection area 104. In the depicted apparatus 100 of FIG. 1, objects 102 travel along a travel path or main transport direction (direction T indicated by arrow) through the inspection area 104 by means of a conveyor system 108. The objects 102 to be inspected may be moveable along said travel path by other means, wherein some non-limiting examples include e.g., by means of sliding (along a horizontal plane or an inclined plane) or freefalling. Hence, the conveyor system 102 of FIG. 1 is optional. The objects may be moved continuously or intermittently along the travel path. In FIG. 1, the inspection system 1 is illustrated as being arranged to inspect objects generally below the inspection system 1. The inspection system 1 is however not limited to only being arranged to inspect objects generally moving below the inspection system 1; the inspection system 1 may alternatively be arranged and/or oriented to be able to inspect objects generally passing to the side of the inspection system 1.

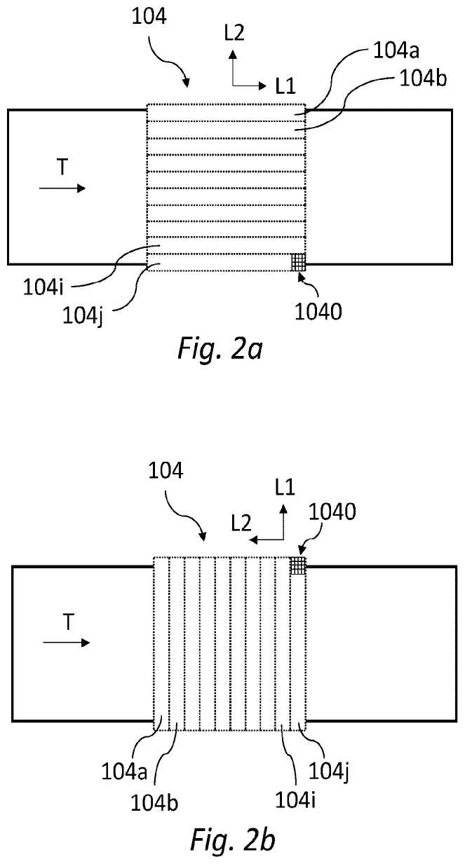

The inspection system 1 may comprise a housing 110 for housing at least some of the components of the inspection system 1. The inspection system 1 may be at least partly arranged in a housing 110. The housing 110 may be arranged above or to the side of the predetermined travel path of objects to be inspected. In FIG. 1, the housing 110 is arranged above the conveyor system 108. The inspection system 1 is adapted to receive and analyze optical radiation which is at least one of emitted, reflected and scattered by and/or transmitted through said objects. The inspection system 1 is discussed in more detail in reference to for example, FIGS. 2a, 2b and other figures below.

The depicted apparatus or sorting system 100 of FIG. 1 further includes an ejection arrangement 112 provided downstream of the inspection area 104. The ejection arrangement 112 is adapted to eject and sort the objects 102 into at least two different destinations. The ejection arrangement 112 however is optional.

The depicted apparatus 100 of FIG. 1 may further include a control cabinet 111. The control cabinet 111 may be arranged above the conveyor system 108. The control cabinet 111 includes equipment used for controlling the apparatus 100. The equipment typically includes a processing unit 113 or control unit for controlling the conveyor system 108, the ejection arrangement 112, and the equipment in the housing 110. The processing unit 113 is typically used to determine properties or a property of the objects 102 based on a measurement carried out by the equipment in the housing 110.

The inspection system 1 may comprise a control unit configured to estimate motion of the objects and/or tracking a trajectory of the objects when the objects are passing through the inspection zone 104. This may facilitate inspection of objects being inspected by the inspection system 1.

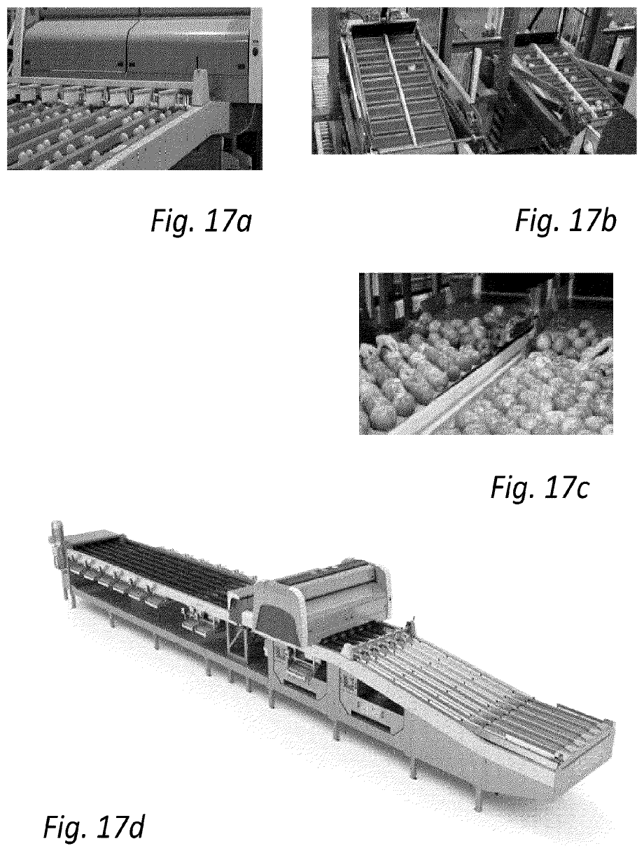

According to one example the inspection system may comprise a conveyor provided with a structure which separates the object stream into separate lanes, as shown in FIGS. 17a and 17d, which are two different views of the same machine according to one mode of operation. A transporter provided with a structure for transporting the objects in separate lanes and separate containers is shown in FIG. 17b. A transporter provided with a structure for transporting the objects in separate lanes is also shown in FIG. 17c, the surface on which the objects rests may be configured so as to prevent the objects from rolling e.g., by means of high friction or by a separate compartment or cup for each object.

The inspection system 1 comprises means for inspecting different inspection zones of the inspection area 104. The inspection area may be characterized by a predetermined length and width. Said predetermined length, and width may be selected depending on object inspection parameters, such as object type, object size, desired and/or expected object throughput.

As illustrated in FIGS. 2a and 2b, the inspection area 104 may be divided into a plurality of inspection zones 104a, 104b, 104i, 104j arranged side-by-side. The inspection zones of the inspection area 104 may be of the same size or the inspection zones may have different sizes, and characterized by an extension along a first direction L1 and an extension along a second direction L2 at a right angle with the first direction L1. The inspection area 104 may be divided into a plurality of inspection zones 104a, 104b, 104i, 104j wherein the inspection zones extend parallelly along the first direction L1. The inspection zones may each have a longitudinal extension along the first direction L1. The inspection zones may be elongated inspection zones 104a, 104b, 104i, 104j, for example, substantially rectangular, and extend longitudinally along the first direction L1.

The inspection area 104 may be divided into any suitable number of inspection zones. For instance, the inspection area 104 may be divided into 2, 3, 4, 5, 6, 7, 8, 9, 10, or more inspection zones.

FIG. 2a depict an inspection area 104 comprising ten parallel and elongated inspection zones 104a, 104b, 104i, 104j and oriented so they extend longitudinally along L1, substantially parallel to a travel direction T of objects moving through the inspection area.

Meanwhile, FIG. 2b depict an inspection 104 comprising ten parallel and elongated inspection zones 104a, 104b, 104i, 104j and oriented so they extend longitudinally along L1, substantially orthogonal to a travel direction T of objects moving through the inspection area.

The inspection system 1 is adapted for being capable of inspecting each individual inspection zone 104a, 104b, 104i, 104j. Thus, an object and/or an conveyor surface for carrying object arranged in said inspection area 104 may be partially located in different inspection zones 104a, 104b, 104i, 104j so the object's parts may be inspected individually e.g. by use of different reflective surfaces of the scanning element.

Further, as exemplified in FIGS. 2a, 2b, an inspection zone may be divided into a 2D and/or 3D arrangement of inspection subzones or detection zones, each inspection subzone 1040 or detection zone 1040 preferably corresponding to the field of view of one of said at least one detector. The number of detection zones in one inspection subzone may for example be 2, 3, 4, 6, 8, 9, 12, 16 or more than 16. Specifically, in FIGS. 2a, 2b, the inspection subzone 1040 is divided into a 2D arrangement of 16 detection subzones. The inspection system 1 may be adapted so that each detection subzone corresponds to one 2D pixel of an image data or spectral data obtained by means of a detector of the inspection system 1. In the case of a 3D arrangement of detection subzones, each detection subzone may correspond to a 3D pixel or voxel of an image data or spectral data obtained by means of a detector of the inspection system 1.

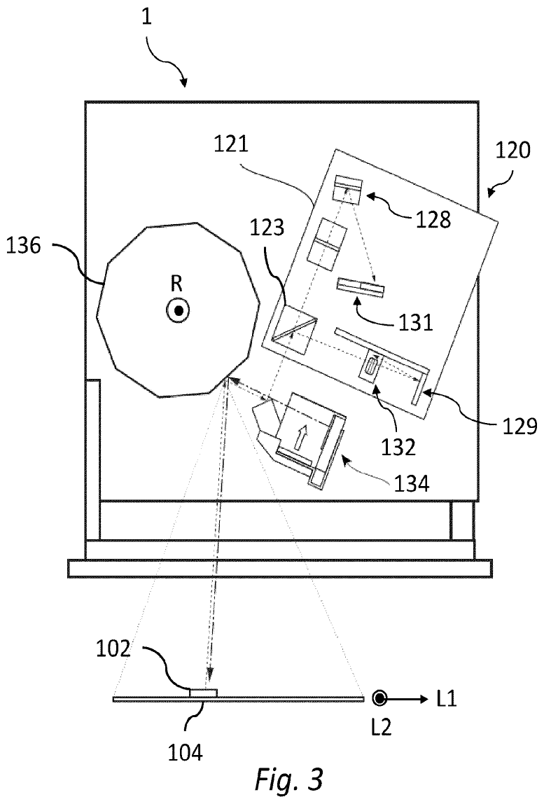

At least some components of the inspection system 1 is schematically illustrated in FIG. 3. Said at least some components may be adapted to be arranged in the housing 110 shown in FIG. 1.

The inspection system 1 comprises a detector system 120. The detector system 120 is provided with at least one detector 131, 132 arranged and oriented so that it is able to receive optical radiation originating from an object 102 arranged in the inspection area 104. The inspection system 1 further comprises a scanning element 136 for receiving optical radiation originating from an object arranged within the inspection area 104 and redirecting said optical radiation towards said at least one detector 131, 132, either directly or by means of further optional optical arrangement 123, 128, 129, thereby providing said at least one detector 131, 132 with a field of view of at least a portion of the inspection area.

The inspection system 1 may comprise an irradiation arrangement adapted for providing an irradiation beam for irradiating the inspection zone 104 at least partially. The inspection system 1 comprises at least one irradiation arrangement adapted to emit optical radiation towards the inspection area 104 and/or said object 102, preferably by said optical radiation being reflected by said scanning element 136. Said at least one irradiation arrangement preferably comprises an illumination source selected from the group comprising LEDs, halogen lamps, and/or lasers.

By operating the scanning element 136, the irradiation beam of optical radiation may sweep over the inspection area along a first direction L1. The first direction L1 may be orthogonal to a second direction L2. The first direction L1 and the second direction L2 may together define a plane along which the inspection area spans. The plane may be substantially parallel to a surface of the inspection area and/or a conveyor surface if present. The inspection system 1 may be adapted to provide the irradiation beam so that it is able to irradiate objects 102 in the inspection area at a non-orthogonal angle with the second direction L2. Alternatively, the irradiation beam is provided so that it is able to intersect objects 102 at an orthogonal angle with the second direction L2.

The inspection system 1 may further comprise a first optical arrangement 134. The first optical arrangement 134 is adapted to direct and optionally converge the at least one irradiation beam towards the scanning element 136. The scanning element 136 is adapted to redirect the at least one irradiation beam along an irradiation direction towards the inspection area 104 and an irradiated area that is moveable relative the inspection area by operating the scanning element 136. The first optical arrangement 134 is preferably configured to focus the at least one irradiation beam in or in the vicinity of the inspection area 104.

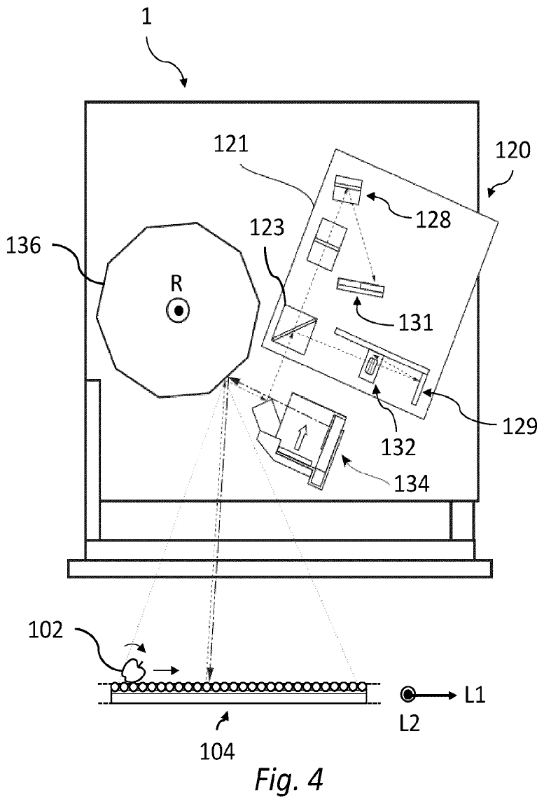

If the scanning element 136 of FIG. 3 is in the form of a rotational polygon mirror that is rotatably arranged to rotate around a first rotational axis R, a rotation of the rotating the polygon mirror will redirect the at least one irradiation beam in the inspection area 104 and a shift of the irradiation area within the inspection area 104 will occur. The at least one irradiation beam will hence be repeatedly redirected along the inspection area for each revolution of the polygon mirror. The scanning element 136 will be discussed in more detail in reference to FIG. 4 and other figures below.

The inspection system 1 is adapted to receive and analyze optical radiation which is at least one of emitted, reflected and scattered by and/or transmitted through said object 102 within said inspection area 104. The radiation which is emitted, reflected and scattered by and/or transmitted through said object 102 will before reaching said at least one detector impinge on the scanning element 136, i.e., the polygon mirror, from where the optical radiation is received by optical elements 121 of the inspection system. Optionally, the optical path from the polygon mirror 136 to the detector comprises further optical elements such as e.g., a fixed folding mirror, which redirects the radiation reflected by said polygon mirror towards an optional housing 121. The fixed folding mirror may be located in the vicinity of where the at least one irradiation beam exits the first optical arrangement 134.

The at least one detector system may comprise at least one spectrometer or CCD for analyzing spectral characteristics of said objects. One or more spectrometers may be comprised in previously referenced detector or represent said detectors. The at least one detector system may comprise at least one 2D camera.

The detector system may comprise one, two or a plurality of sensors, for example, a first sensor 131 and a second sensor 132. Preferably, each of said one, two or a plurality of sensors is an array or matrix sensor, comprising a plurality of pixels. Each pixel may be associated with a respective detection subzone as indicated in FIGS. 2a, 2b. Further, each sensor 131, 132 is preferably associated with a respective diffractive element 128, 129 such as a grating, which pairs of sensors and diffractive elements are arranged at different locations and arranged to receive a respective portion of the optical radiation 122, wherein different portions of the optical radiation 122 are directed towards the first diffractive elements 128, and the second diffractive element 129, respectively. The optical radiation 122 may e.g., be split in the two different portions by means of a beam splitting element 123.

More than one spectrometer may be used in the apparatus 100. For instance, the detector system may include a first sensor 131 adapted to analyze light of a first wavelength interval and a second sensor 132 adapted to analyze light of a second wavelength interval. As an example, a first spectrometer may be adapted for analyzing light in the wavelength interval 450 nm-800 nm and a second spectrometer may be adapted for analyzing optical radiation in the wavelength interval 1500 nm-1900 nm. For instance, one spectrometer for analyzing visible light may be used in combination with one NIR spectrometer.

Similarly, two, three or more spectrometers may be included in the detector system 120. Hence, three or more spectrometers may be used. For instance, one spectrometer may be adapted for analyzing visible light, may be used in combination with two NIR detectors. (for example, 400-700 nm, 700-1100 nm, 1100-1800 nm)

The inspection system further comprises a processing circuitry configured to execute: a data collection function configured to collect spectral data associated with spectral characteristics of said objects based on a signal from the spectrometer, which spectral data pertains to said optical radiation originating from said objects when arranged in at least one of said first number of inspection zones; a data processing function configured to provide an object representation based on said spectral data, and an outputting function configured to output object information based on said object representation.

For instance, spectral analysis may be used to determine characteristics of objects being inspected. Characteristics of objects may include presence of specific substances and/or components, which may be used to infer a condition of an object, such as ripeness and/or dryness of edibles; temperature, oxidation, etc.

FIG. 4 illustrates the inspection system 1 according to one embodiment. The objects 102 are rotated while being conveyed along the object travel path and rotated by means of rotating means arranged at the inspection zone. In the exemplary embodiment illustrated, the rotating means are provided as a plurality of rollers adapted to rotate about a respective rotational axis parallel to the second direction L2. Thereby, the object 102 is rotated as it passes through the inspection area. This enables a larger part of the object 102 to be exposed for inspection by the inspection system 1, for example, full 360° inspection of the object.

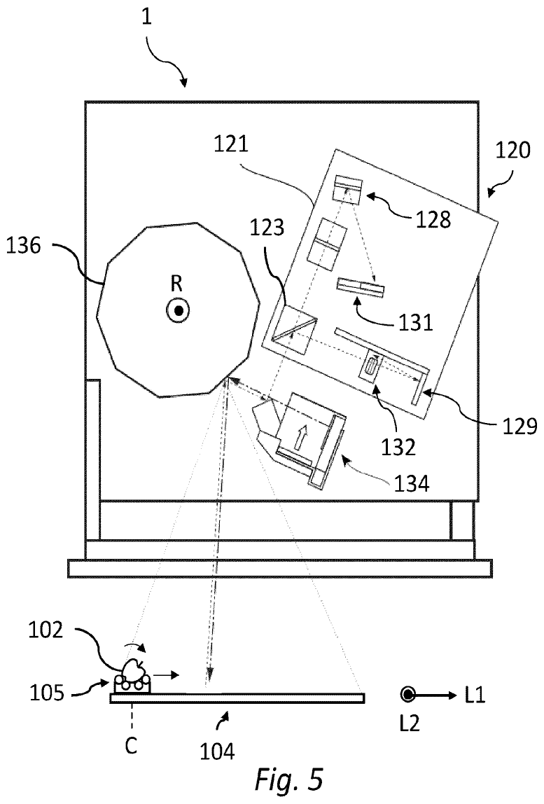

FIG. 5 illustrates the inspection system 1 according to one embodiment. The objects 102 are provided by holding means for holding the respective object to be inspected. This may enable accurate orientation of the object as it is conveyed through the inspection area. Each holding means may be provided with a space or compartment for holding the object 102. The holding means may comprise rotating means for rotating the object. Although not shown in FIG. 5, the holding means may be adapted to rotate about a rotational axis C that is substantially orthogonal to a first and/or second direction L1, L2. The holding means may be a holder, container, or the like.

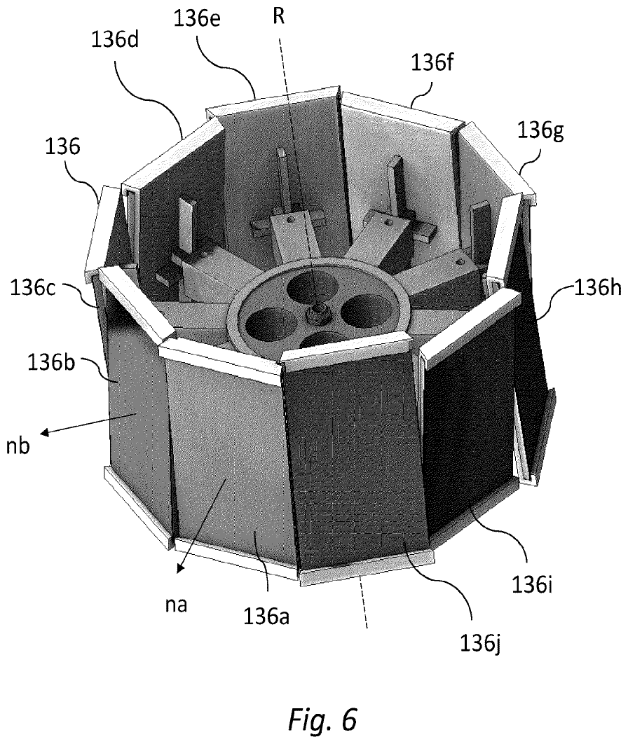

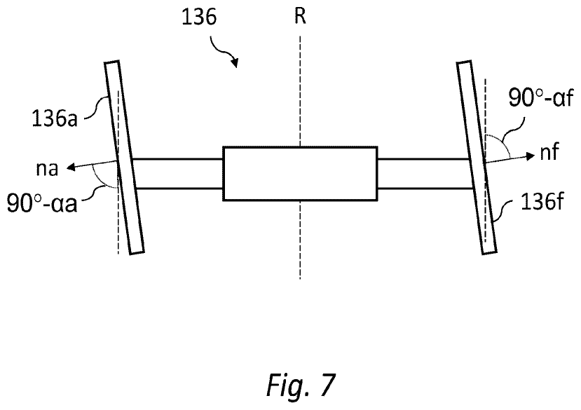

The scanning element 136 will now be discussed in more detail with FIG. 6 as a starting point. The scanning element 136 comprises a set of reflective surfaces 136a, 136b, . . . , 136j arranged one after another around a first rotation axis R around which the scanning element 136 is configured to rotate. Thus, by rotating the scanning element 136 around the first rotation axis R, the detector's field of view can be moved within the inspection area 104 in a direction substantially parallel or anti-parallel with a first direction L1 in a sweeping motion. The scanning element 136 has a set of surface normals na, nb, . . . describing the orientation of each respective reflective surface 136a, 136b, . . . , 136j of the set of reflective surfaces 136a, 136b, . . . , 136j of the scanning element 136. Said surface normals na, nb, . . . may be respective center surface normals, meaning surface normals at the respective center of each reflective surface. The orientation of each reflective surface may be described using the relative angle between each surface normal and a respective nominal surface normal defined as substantially orthogonal to the first rotation axis; such relative angle is henceforth referenced as the inclination angle α, see FIG. 7. For a surface normal which is orthogonal to said rotation axis in all directions, the inclination angle α is 0 degrees.

In general, the respective inclination angles may be selected from an interval of ±1°, ±2°, ±3°, ±4°, ±5°, ±6°, ±7°, ±8°, ±9°, ±10°, ±15°, ±20°, or ±40°.

At least two reflective surfaces 136a, 136f of the set of reflective surfaces 136a, 136b, . . . of the scanning element 136 are arranged so that the respective surface normals na, nf of said at least two reflective surfaces 136a, 136f are angled at different inclination angles αa, af to the first rotation axis R. This is illustrated in FIG. 5 representing a schematic side view of the scanning element 136 according to one embodiment of the invention. By this, the detector's field of view can be offset in a second direction L2 different from the first direction L1 when rotating the scanning element 136 to change which of said at least two reflective surfaces 136a, 136f of the set of reflective surfaces 136a, 136b, . . . redirects the detector's field of view to the inspection area 104.

As stated previously, the inspection area 104 may be divided into a plurality of parallel inspection zones. Inclination angles of the respective reflective surfaces may be selected so that each reflective surface redirects the detector's field of view to a particular and optionally unique inspection zone 104a, 104b, . . . of the inspection area 104. The number of inspection zones 104a, 104b . . . that may be inspected by the inspection system 1 may be determined by the number of unique inclination angles represented by the reflective surfaces of the set of reflective surfaces 136a, 136b, . . . of the scanning element 136.

For instance, two reflective surfaces of the scanning element 136 may be angled to the first rotation axis R by a first inclination angle and two other reflective surfaces of the scanning element 136 may be angled to the first rotation axis by a second inclination angle different from the first inclination angle. Thereby, the scanning element 136 comprises four reflective surfaces, yet only two inspection zones of the inspection area will be inspected, given that all four reflective surfaces have the same shape.

In one preferred embodiment, each reflective surface of the set of reflective surfaces 136a, 136b, . . . have the same shape and is arranged at a different, i.e., unique, inclination angle to the first rotation axis R. This results in that a number of substantially identical elongated inspection zones arranged parallelly in the inspection area may be inspected. As an example, the scanning element 136 comprises ten reflective surfaces. If each of these are angled differently to the first rotation axis R by a respective inclination angle, an inspection area 104 divided into ten parallel inspection zones may be inspected upon a rotation of said scanning element.

All, or a majority of the reflective surfaces of the set of reflective surfaces 136a, 136b, . . . may have substantially the same shape and surface area. For instance, the shapes of the reflective surfaces may be flat. They may additionally or alternatively have at least partially or wholly concave or convex shapes. The scanning element may be adapted so that each one of said set of reflective surfaces comprises an at least locally flat reflective surface representing a surface area of at least 80% of the whole surface area of said each one of said set of reflective surfaces. Optionally, the surface outside the locally flat reflective surface is convex so as to increase the field of view for the detector. Preferably the surface on the respective lateral sides of the locally flat reflective surface is convex. The lateral side is arranged to the side of the locally flat surface in a direction parallel with the rotation axis.

The scanning element 136 may comprise an even number of reflective surfaces 136a, 136b, . . . . Each reflective surface 136a, 136b, . . . may have a corresponding reflective surface arranged on the opposite side of said scanning element 136, thereby forming pairs of opposite reflective surfaces as illustrated in FIGS. 4 and 5, wherein all the reflective surfaces and for example, 136a and 136fform respective pairs of opposite reflective surfaces. The reflective surfaces of each pair of opposite reflective surfaces may be oriented so that their respective surface normal are substantially parallel. For a pair of reflective surfaces having a surface normal that is orthogonal to the first rotational axes in all directions, both reflective surfaces redirect the field of view to the same inspection zone that may be referred to a middle inspection zone. For the reflective surfaces shown in FIG. 6 none of the reflective surfaces redirects the field of view to such a middle inspection zone. In FIG. 6 each reflective surface, in a pair of opposite reflective surfaces having substantially parallel center normal, redirects the field of view to a separate or different inspection zone, the two inspection zones being arranged on a respective lateral side of a center line in the inspection area. According to one non-limiting example the scanning element has 5 pairs of opposite reflective surfaces, wherein the surface normal of the reflective surfaces deviates from an orthogonal surface normal by 0.9°, −2.7°, 4.4°, −6.2°, 8°, −0.9°, 2.7°, −4.4°, 6.2°, −8° as seen clockwise around the scanning element.

FIG. 7 illustrates two reflective surfaces with surface normals na, nf having opposite inclinations, meaning that the deviation aa, af from the first rotational axis is the same, but a projection of the surface normal na, nf along the first rotational axis R are directed opposite directions. The reflective surfaces of each pair of reflective surfaces may be oriented so that their respective surface normals are substantially parallel and surface normal projections along the first rotational axis R are oriented in opposite directions along the first rotational axis. According to one example, the scanning element may comprise two reflective surfaces, which surface normals have opposite inclinations. These two reflective surfaces may be arranged opposite each other, or next to each other or have any other position around the rotation axis. The reflective surfaces may be provided by mirrors. The mirrors may be rotatable about a rotation point for adjusting the inclination angle. The rotation point of a mirror may be located substantially at a center of mass of the mirror. By this, opposing pairs of mirrors may be balanced in terms of mass.

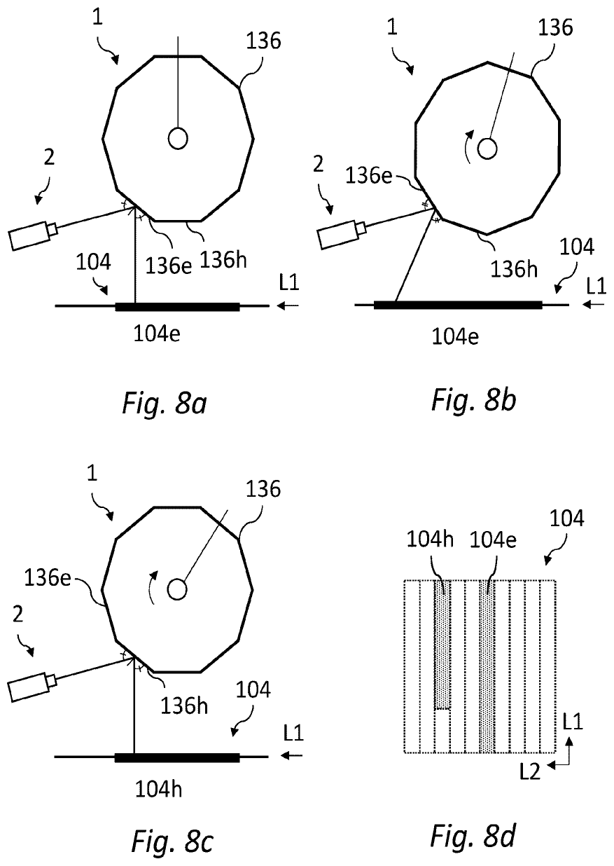

FIGS. 8a-8c schematically illustrate how a detector's 2 field of view sweeps over an inspection zone 104e, 104h of the inspection area 104 by rotating the scanning element 136 around the first rotational axis R. In FIG. 8a, the detector's 2 field of view is redirected to the inspection area 104 via a first reflective surface 136e of the scanning element 136. As the scanning element 136 rotates relative the first rotational axis R into a position as indicated in FIG. 8b, the detector's field of view sweeps along an inspection zone 104e along a first direction L1. When the scanning element 136 rotates further, the detector's 2 field of view will eventually be redirected to the inspection area 104 by a second reflective surface 136h as shown in FIG. 8c. Provided that the second reflective surface 136h is angled differently to the first rotation axis R than the first reflective surface 136e, the detector's 2 field of view will be offset along a second direction L2 so that the detector 2 is inspecting another inspection zone 104h. The scanning effect of the inspection area 104 is visualized in FIG. 8d.

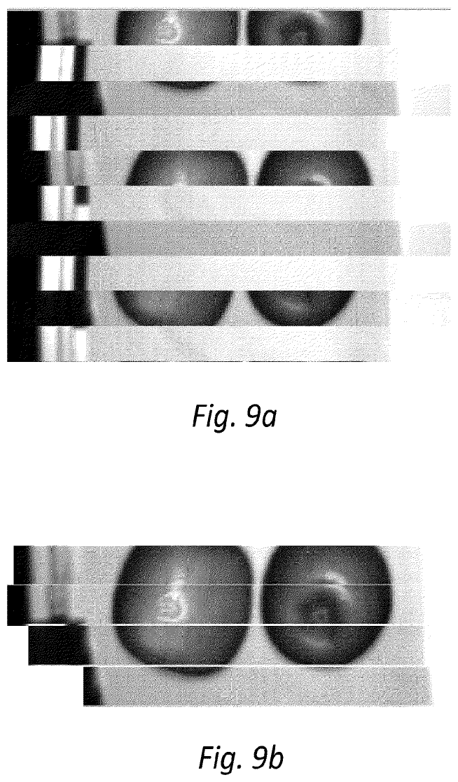

FIGS. 9a and 9b illustrate images captured from different inspection zones within the inspection area wherein two objects, specifically apples, are located. Due to the reflective surfaces being arranged in a particular order, for instance arranged so as to maintain a beneficial weight center substantially intersected by the first rotation axis, the images captured may be provided in an unordered manner. FIG. 9b show when the images are rearranged in consecutive order. The apples shown in FIG. 9a each extends across 4 inspection zones simultaneously when the objects are transported passed the inspection area.

Moreover, when objects 102 being inspected are rotated within the inspection area 104 a full 360° spectral representation of the object may be obtained. A full 360° spectral representation may be obtained also when the objects are transported through the inspections area, provided that at least a full rotation of the object is provided within the inspection area, this is possible both when the longitudinal extension of the inspection zones is parallel with the transport direction. In principle this is possible for any orientation of the longitudinal extension of the inspection zones relative the transport direction, as long as the transport velocity and object rotation speed are adapted to the situation at hand.

This may require a transport system that not only enables objects to be transported within the inspection zones, but also enables a rotational movement of said objects. The inspection system may thus comprise carrier, holder, bracket, fixture and/or support for transporting objects within the inspection area, wherein said transportation means are also configured to provide a rotational movement of said objects. This enables the detector system 1 to establish a 360° spectral representation of the object.

Said transportation means may be configured to transport the objects 102 passing through the inspection area 104 in a direction L1 substantially along, transvers or orthogonal to the longitudinal extension of said first number of elongated inspection zones 104a, 104b, . . . and wherein the first rotation axis R is arranged traverse to said direction L1. Alternatively, said transportation means are configured to transport the objects 102 passing through the inspection area 104 in a direction along, transverse or orthogonal to the longitudinal extension of said first number of elongated inspection zones and wherein the first rotation axis is arranged substantially parallel to said direction L1. Said transportation means may be a conveyor system with means to provide said rotational movement of objects to be inspected.

The scanning element may further comprise a plurality of base members, and each reflective surface may be attached to a respective one of said base members in said plurality of base members.

According to one embodiment, the scanning element comprises a plurality of mirror elements, each mirror element comprising a respective one of said reflective surfaces. Preferably, each base member comprises a bracket element adapted in shape and size for holding said mirror element at a desired inclination angle.

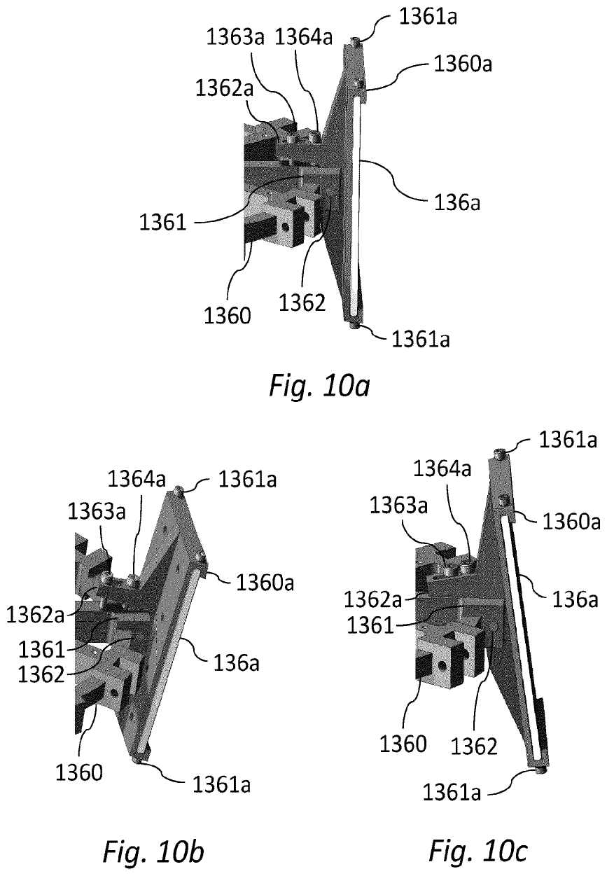

FIGS. 10a-10c illustrate the scanning element 136 according to one embodiment. In FIG. 10a, the reflective surface 136a is provided by a mirror element which is attached to a base member 1360 of the scanning element 136 by fixation means. The fixation means may be a glue or adhesive. Alternatively, or additionally, the fixation means 1360 may comprise a bracket element 1360a for securing the mirror element to said base member. The bracket member may comprise fastening means 1361a. In FIG. 10a-10c, the fastening means is exemplified as screw elements. Alternatively, the fastening means may be for instance be clamps adapted for clamping the mirror element securely in place, or pins adapted to extend into recesses provided in the mirror element. The bracket element is adapted to be attached to the base member via respective fastening means 1363a, 1364a. Said fastening means 1363a, 1364a may be screw elements.

According to one embodiment, the bracket element 1360a is pivotably attached to the base member 1360. The bracket element 1360a may be pivotably attached to the base member 1360 via an axle element 1362 adapted to be fixedly attached to the bracket element 1360a and extend into corresponding axle aperture(s) arranged on a receiving member 1361 provided by the base member 1360. The receiving member 1361 may be adapted in shape and size to define a guide slot for receiving at least a portion of the bracket element and for guiding the bracket element to pivot about a pivot axis defined by the axle element 1362. By operating the fastening means 1363a, 1364a, the inclination angle of a reflective surface may be adjusted. One of the fastening means 1363a may be adapted to interact with a fastening means aperture provided in the base member 1360. The bracket element 1360a may be adapted with a fastening means receiving portion 1362a providing a guide slot for receiving the fastening means 1363a. Thereby, depending on how the fastening means 1363a is configured, the inclination angle of the reflective surface may be adjusted. FIG. 10b show when the reflective surface 136a is configured at a first inclination angle and FIG. 10c show when the reflective surface 136b is configured at a second inclination angle different from said first inclination angle.

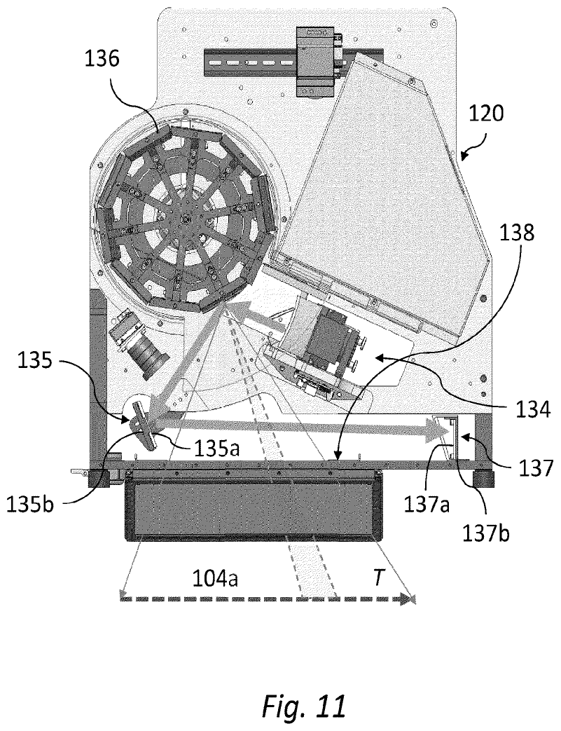

FIG. 11 show the inspection system 1 according to one embodiment of the invention. This embodiment comprises a reflective member 135 arranged and oriented to redirect the field of view of said detector system 120 to a reference surface member 137 provided with a reference surface 137a. The reflective member 135 may comprise a reflective mirror providing a reflective surface 135a and a bracket element 135b for holding the reflective mirror. By the reflective member 135, the detector system 1 will be redirected towards said reference surface 137a each time the scanning element 136 rotates so that a succeeding reflective surface redirects the field of view of the detector system 120, for example, once per reflective surface and before the field of view is redirected to the beginning of one inspection zone. The reference surface 137a may when detected in the captured image data, be used when matching image data from different detection zones. Further, in FIG. 11, the field of view of the detector system 120 is indicated by the slightly transparent region between the dashed arrows sweeping over the detection zone 104a. The dashed arrow 104a, as well as the line arrows schematically indicate the extension of the inspection zone, and the dashed arrow indicates the direction in which the field of view is redirected along the inspection zone. The reference surface 137a may be a surface providing a specific pattern or color. In one example, the reference surface 137a is fully colored white reference, and/or a black reference.

Additionally, or alternatively, a reference element 138 may be provided after the end of the inspection zone. If this reference element is implemented in FIG. 11, the inspection zone would be shortened.

In the embodiment shown in FIG. 11, the target calibration arrangement 137,138 is arranged downstream of the scanning element and upstream of the inspection area as seen in the direction of the irradiating illumination.

According to one embodiment, the spectral data S can be normalized as follows: S′=(S−D)/(W−D) where W is the white spectrum and D the dark spectrum detected in 137 and 138. This method compensates temperature fluctuations caused in optical components, detector and electronics and illumination aging effects from the spectral data.

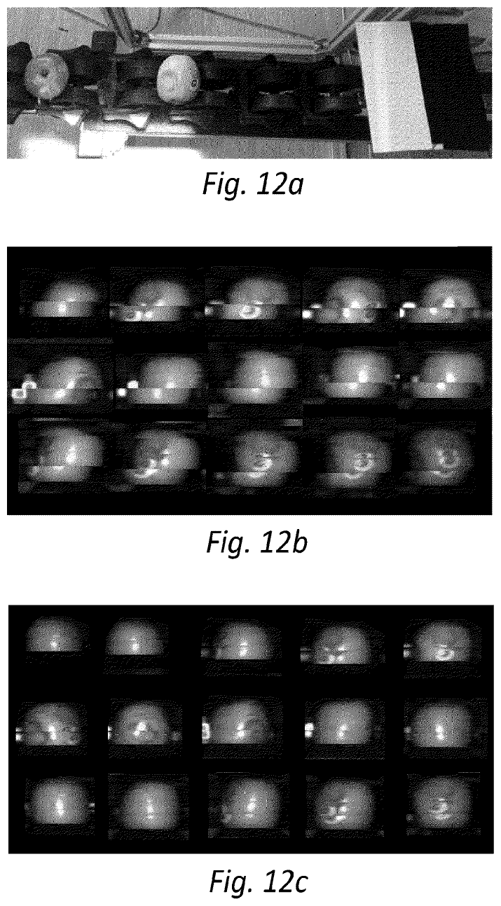

FIG. 12a illustrate the invention according to one embodiment wherein the objects are carried by one by one by a carrier or holing means having a separate compartment for each object. Each compartment comprises rotating means for rotating the objects, here apples. The holding means are adapted to be transported through the inspection area by means of a conveyor system. The inspection system is optionally adapted to monitor and track the transport speed and/or rotation speed of the objects. The inspection system may be adapted to enable this information about transport speed and/or rotation speed to be used in order to relate image data from different detection zones so these can be correctly matched. This may be henceforth referenced as speed compensation.

FIG. 12b indicate image data obtained when inspecting an apple rotating as it is transported through the inspection area. The image data represent a plurality of snap shots of the apple, in time ordered from upper left in sequence to bottom right, wherein each snapshot comprises image data from different inspection zones, each snapshot being similar to what has been described in relation to FIG. 9b. Without incorporating speed compensation, the image data from the respective detection zones are not aligned for each snapshot. By incorporating speed compensation, the image data from the respective detection zones may be aligned for each snapshot. Although, FIGS. 12a-12b show a plurality of snapshots, the speed compensation may be implemented continuously throughout the inspection of objects within the inspection area.

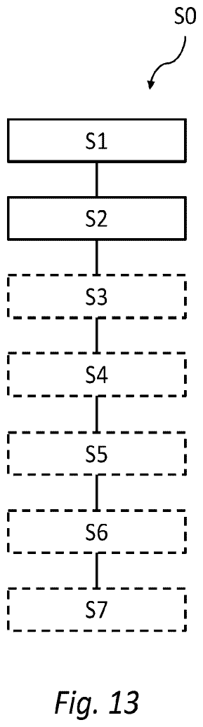

FIG. 13 illustrates a flow chart of a method S0 for inspecting objects 102 passing through an inspection area 104 by an inspection system 1 which inspection area 104 is divided into a plurality of elongated inspection zones 104a, 104b, . . . having a longitudinal extension, wherein said inspection system 1 comprises a scanning element 136 arranged to rotate around a first rotation axis R and comprising a first set of reflective surfaces 136a, 136b, . . . arranged one after another around said first rotation axis R, the inspection system 1 further comprising at least one detector 2 having a field of view for receiving optical radiation, the method S0 comprising the steps of: a step S1 of receiving, by the at least one detector 2, optical radiation originating from an object 102 arranged in at least one of said first number of inspection zones 104a, 104b, . . . ; a step S2 of rotating the scanning element 136 such that each one of said surfaces 136a, 136b, . . . redirects the field of view of said detector 2 to a different one of said first number of elongated inspection zones 104a, 104b, . . . and such that each one of said surfaces 136a, 136b, redirects the field of view along the extension of the respective elongated inspection zone 104a, 104b, . . . of the inspection area 104.

The method S0 further comprises a step S3 of transporting the objects 102 through said inspection area 104 in a direction transverse or substantially parallel to the longitudinal extension of the inspection zones 104a, 104b, . . . , and a step S4 of rotating the objects 102 when the objects 102 are transported through said inspection area 104.

The method S0 further comprises a step S5 of measuring spectral characteristics of the objects 102 passing through the inspection zone 104a, 104b, . . . of the inspection area 104. Said measurement may be carried out by spectrometers previously discussed.

The method S0 further comprises a step S6 of measuring spectral characteristics of the objects 102 passing through the inspection zone 104a, 104b, . . . at different sides of the objects 102 and preferably a step S7 of creating a 360° spectral representation of the object 102.

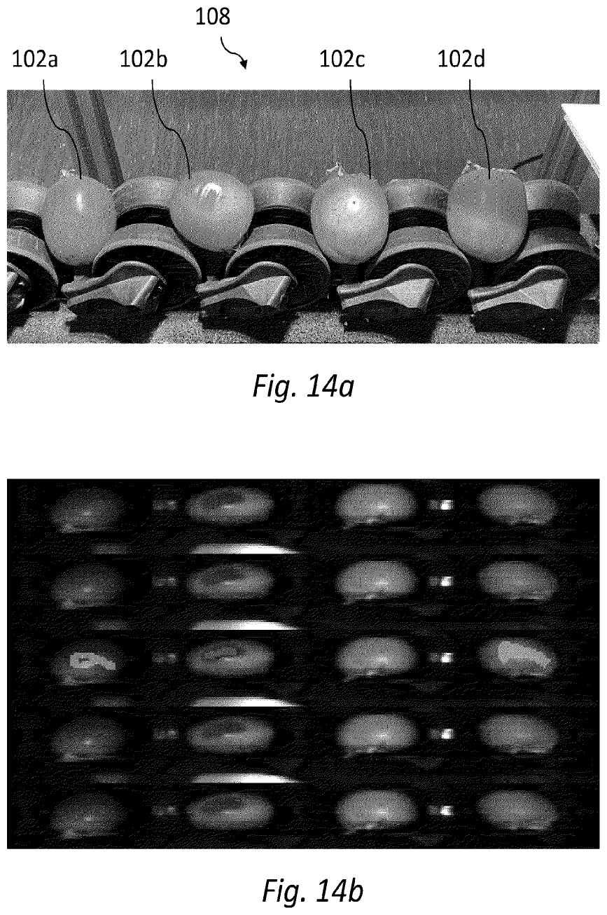

FIGS. 14a, 14b show objects 102a-102d arranged in respective compartments of a conveyor system. Each respective compartment is at least partly formed by respective rotating means that interact with different sides of said objects 102a-102d. The respective rotating means is here exemplified as wheel members rotatable around an axis but may alternatively be rollers or the like. The conveyor system is adapted so that the rotating means may be transported along the conveyor system, thereby the compartments formed is consequently also transported along the conveyor system. Each compartment may be adapted to hold individual objects to be inspected. Specifically, the objects 102a-102d are fruits.

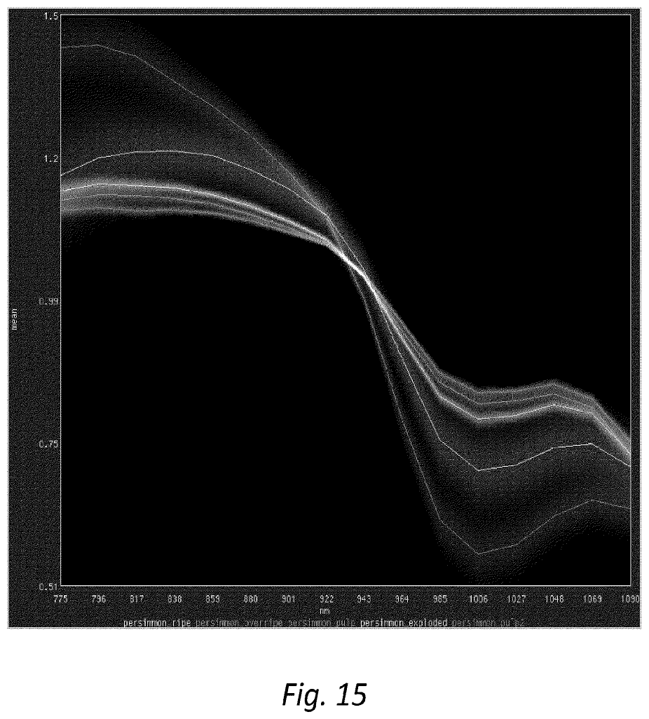

FIG. 15 illustrate inspection scans of the respective fruits 102a-102d in which different regions of interests have been identified. In the left-most vertical set of scans, a first property within a region of interest has been identified. This region is illustrated by the color yellow. In the other vertical set of scans, respective properties in detected region of interests have been identified which regions are indicated by colors blue, red, purple, and green respectively.

The detected region of interest may be determined from spectrum data, see FIG. 15, wherein each line is associated by color to each region of interest detected. The wavelength range on the x-axis is 775 nm to 1090 nm, the intensity of the y-axis is 0.51 to 1.5. By the peak responses in the spectra for various wavelengths, one or more properties of the fruits, and more generally any objects inspected, may be determined. One of said properties may be ripeness of said fruits or whether the fruits contain a certain water content or is otherwise exposed to various chemicals and/or substances, such as pesticide. The fruits may then be sorted based on said detected properties. For example, fruits which are unsuitable for eating may be classified based on said identified properties and may be sorted to be discarded. Fruits suitable for eating may be sorted also, in terms of ripeness, and may be categorized accordingly.

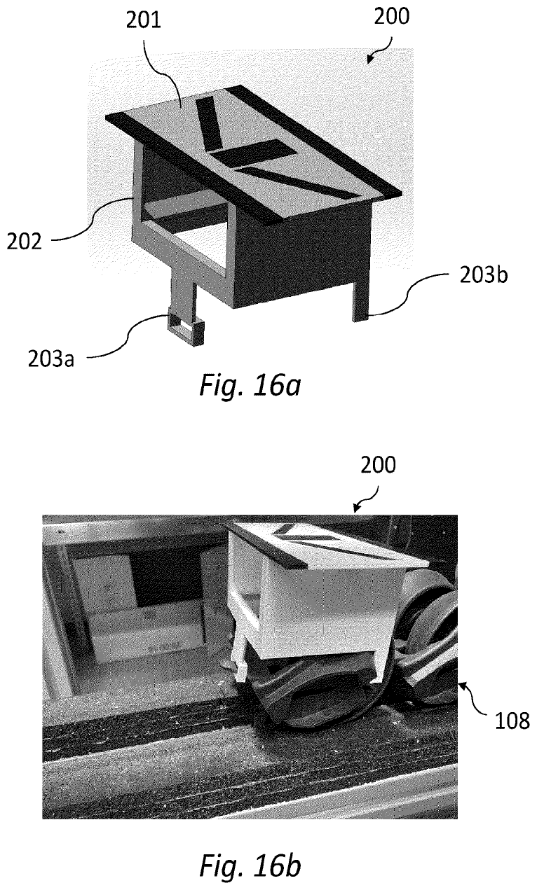

FIGS. 16a, 16b show a target calibration arrangement 200 according to one embodiment of the invention. The target calibration arrangement 200 is adapted in size and shape to provide a calibration surface 201 provided with a geometric shape and/or pattern.

In the exemplary target calibration arrangement 200 illustrated in FIGS. 16a, 16b, the pattern comprises two black edge regions extending along opposite surface edges of the calibration surface 201. In between said two black edge regions, three separate black centre regions are provided. The three separate black centre regions are separated from each other and substantially arranged in series in a traverse direction between the two black edge regions. The outer centre regions extend in respective longitudinal directions which directions are at a non-orthogonal angle with each other. The middle centre region of the three centre regions extends in a longitudinal direction substantially directed between the two edge regions. This pattern is an exemplary pattern which enables the inspection to inspect the target calibration arrangement to provide calibration data on how the inspection system it to be calibrated in terms of detector settings, such as focal point of the detector, colour setting, allocating binds of a spectrometer to different wavelengths, allocating each detection zone with a set of pixels, or the like.

The target calibration arrangement 200 may further comprise a body 202 to which the calibration surface is provided. The target calibration arrangement 200 may further comprise attaching means 203a, 203b for attaching the target calibration arrangement 200 to a conveyor system 108. The attaching means 203a, 203b may be provided on supporting member, e.g., legs, by which the target calibration arrangement 200 may be placed to elevate it from a surface. One or more of the attaching means 203a, 203b may be provided as a structure 203a adapted in shape and size to define an aperture for receiving a member of the conveyor system 200. One or more of the attaching means 203a, 203b may be flange structure for stabilising the calibration arrangement 200 to the conveyor system 108.

FIG. 16b show when a target calibration arrangement 200 has been arranged to a conveyor system 108, wherein a protruding member extends through the aperture associated with one of the attaching means 203a. The conveyor system 108 comprises rotating means in the shape of wheel member. Neighbouring pairs of wheel members arranged along respective rotational axis define respective compartments for holding separate objects to be inspected.

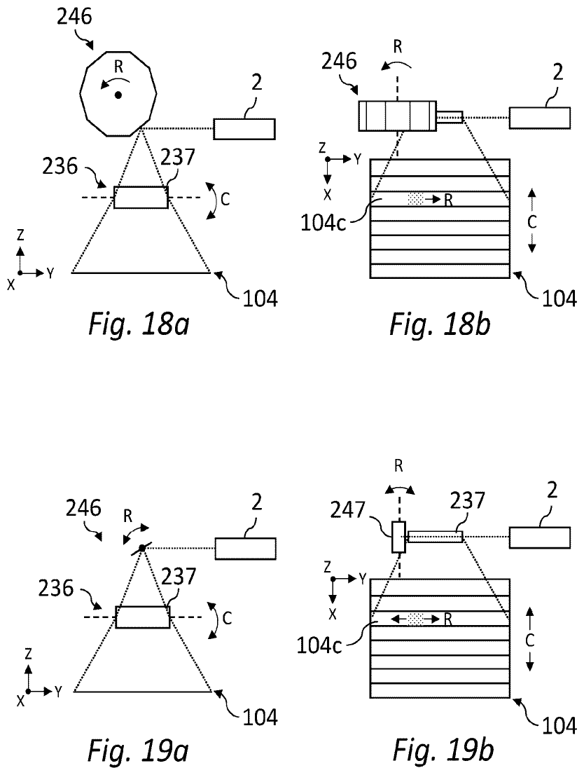

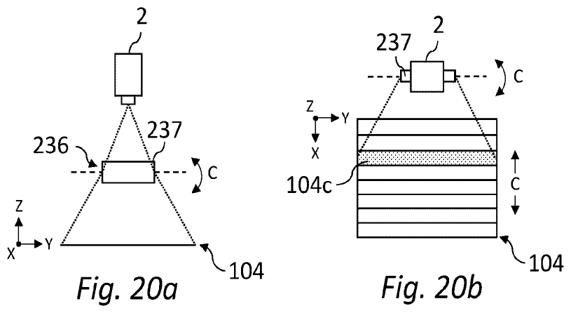

FIG. 20a shows a side view and FIG. 18b a top view of the same inspection system, having only one rotatable reflective surface for redirecting the field of view. The inspection system preferably comprises a detector having a field of view that covers at least one inspection zone in both the x- and y-direction. The inspection system is arranged for inspecting objects passing through an inspection area (104), which inspection area (104) is divided into a plurality of elongated inspection zones (104a, 104b, 104c) having a longitudinal extension, the inspection system (1) comprises:
a detector system with at least one detector (2) and an optical arrangement for receiving optical radiation originating from an object arranged in at least one of said plurality of inspection zones (104a, 104b, 104c) and redirecting said optical radiation towards said at least one detector (2), and providing said at least one detector (2) with a respective field of view;
a first scanning element (236) configured to rotate around a first rotation axis (C) and comprising one reflective surface (237),
wherein the first rotational axis (C) is arranged such that said reflective surface (237) of said first scanning element (236) redirects the field of view of said at least one detector (2) to a respective one of said plurality of elongated inspection zones (104a, 104b, 104c) upon a rotation of said first scanning element (236). In other word, when said reflective surface (237) is rotated or tilted around said first rotational axis, the field of view is redirected in the x-direction. The rotation or tilting of said reflective surface may be continuous or intermittent. The main difference between the embodiment shown in FIG. 20a, 20b and those shown in the prior figures is that the scanning element (136) having a plurality of reflective surfaces has been replaces by one or only one reflective surface.

FIG. 19a show a side view and FIG. 19b a top view of the same inspection system, having two separate rotatable reflective surfaces (237, 247) for redirecting the field of view. In other words, the embodiment shown in FIG. 19a is the same as the one shown in FIG. 20a, except that there is also provided a second scanning element (246) configured to rotate around a second rotation axis (R) and comprising at least one reflective surface, wherein the second rotational axis (R) is arranged such that said reflective surface of said second scanning element redirects the field of view of said at least one detector (2) along the longitudinal extension of the respective elongated inspection zone (104a, 104b) upon a rotation of said second scanning element (136). The second rotational axis (R) is preferably arranged orthonal to or substantially orthogonal to the first rotational axis (C).

According to this embodiment the field of view only covers a portion of the inspection zone in the y-direction, and is redirected along each inspection zone by the second scanning element. Consequently, the rotational or tilting speed of the second scanning element is higher than the first scanning element.

FIG. 18a shows a side view and FIG. 18b a top view of the same inspection system, having two separate rotatable reflective surfaces (237, 247) for redirecting the field of view, where second scanning element (246) is a polygon mirror.

FIGS. 18a, 18b show a side view and a top view of the same inspection system, having a polygon mirror and one rotatable reflective surfaces for redirecting the field of view.

### ITEMISED LIST OF EMBODIMENTS

Item 1. An inspection system (1) for inspecting objects (102) passing through an inspection area (104), which inspection area (104) is divided into a plurality of elongated inspection zones (104a, 104b) having a longitudinal extension, the inspection system (1) comprising:
   a detector system with at least one detector (2) and an optical arrangement for receiving optical radiation originating from an object (102) arranged in at least one of said plurality of inspection zones (104a, 104b) and redirecting said optical radiation towards said at least one detector (2), and providing said at least one detector (2) with a respective field of view;
   a scanning element (136) configured to rotate around a first rotation axis (R) and comprising:
   a plurality of reflective surfaces arranged one after another around said first rotation axis (R), which plurality of reflective surfaces comprises a set of reflective surfaces (136a, 136b) wherein each reflective surface in said set of reflective surfaces is associated with a respective one of said elongated inspection zones,
   wherein the scanning element (136) is configured to redirect the field of view of said at least one detector (2) to each one of said plurality of elongated inspection zones (104a, 104b) once per revolution of said scanning element (136), and each one of said reflective surfaces (136a, 136b) are configured to redirect the field of view of said at least one detector (2) to a respective one of said plurality of elongated inspection zones (104a, 104b) once per revolution of said scanning element (136), and
   the rotational axis (R) is arranged such that each one of said reflective surfaces (136a, 136b) redirects the field of view along the longitudinal extension of the respective elongated inspection zone (104a, 104b) upon a rotation of said scanning element (136).
Item 2. The inspection system (1) according to item 1, further comprising rotating means adapted in size and shape for providing a rotation to the objects so the objects are rotating when passing through the inspection area, wherein said rotating means is preferably selected from a group of rotating means comprising moving belts, rotatable wheels, rotatable rollers, rotatable platforms or the like, wherein said rotating means is preferably provided by a conveyor system.
Item 3. The inspection system (1) according to item 1 or 2, wherein the inspection system further comprises a conveyor being provided with a set of compartments or supporting means, wherein each compartment or supporting means is configured for transporting only one object or between 2-10 objects or between 2-50 objects or more objects passed said inspection area; and wherein the each compartment or supporting means is preferably arranged for rotating the objects carried by said compartment or supporting means when passing said inspection area.
Item 4. The inspection system (1) according to any preceding items, wherein the optical radiation originating from the object (102) is at least one of emitted, reflected and scattered by and/or transmitted through said object (102).
Item 5. The inspection system (1) according to any preceding items, wherein said scanning element (136) has a set of surface normal (na, nb), wherein each one of said surface normals (na, nb) is a center surface normal of a respective one of said set of reflective surfaces (136a, 136b) and wherein each one of said surface normals (na, nb) in said set of surface normals has a different inclination angle (aa, ab) to said rotation axis (R) compared to the other surface normals (na, nb) in said set of surface normal.
Item 6. The inspection system (1) according to any preceding items, wherein each one of said set of reflective surfaces (136a, 136b) comprises an at least locally flat reflective surface representing a surface area of at least 80% of the whole surface area of said each one of said set of reflective surfaces (136a, 136b).
Item 7. The inspection system (1) according to anyone of the preceding items, wherein the reflective surfaces (136a, 136b) have substantially the same shape and surface area and the scanning element (136) optionally comprises an even number of reflective surfaces (136a, 136b) and wherein each reflective surface (136a, 136b) has a corresponding reflective surface arranged on the opposite side of said scanning element (136) and wherein the respective surface normal of said reflective surface and the corresponding reflective surface are substantially parallel.
Item 8. The inspection system (1) according to anyone of the preceding items, wherein said at least one detector system comprises at least one spectrometer for analyzing spectral characteristics of said objects.
Item 9. The inspection system (1) according to item 8, wherein said inspection system (1) further comprises a processing circuitry configured to execute:
   a data collection function configured to collect spectral data associated with spectral characteristics of said objects (102) based on a signal from the spectrometer, which spectral data pertains to said optical radiation originating from said objects (102) when arranged in at least one of said first number of inspection zones (104a, 104b),
   a data processing function configured to provide an object (102) representation based on said spectral data, and
   an outputting function configured to output object information based on said object representation.
Item 10. The inspection system (1) according to anyone of the preceding items, wherein the inspection system (1) comprises a transportation means (108) configured to transport the objects (102) through the inspection area (104).
Item 11. The inspection system (1) according to item 10 when dependent on any one of items 8-9, wherein said transportation means (108) are configured to provide a rotational movement of said objects (102) and wherein the detector system (1) is configured to establish a 360° spectral representation of the object (102).
Item 12. The inspection system (1) according to any one of items 10-11, wherein said transportation means (108) are configured to transport the objects (102) passing through the inspection area (104) in a direction substantially along the longitudinal extension of said first number of elongated inspection zones (104a, 104b) and wherein the first rotation axis (R) is arranged transverse to said direction.
Item 13. The inspection system (1) according to any one of items 10-11, wherein said transportation means (108) are configured to transport the objects (102) passing through the inspection area in a direction transverse to the longitudinal extension of said first number of elongated inspection zones (104a, 104b) and wherein the first rotation axis (R) is arranged substantially parallel to said direction.
Item 14. The inspection system (1) according to anyone of the preceding items, wherein the inspection system (1) comprises a control unit configured to estimate motion of the objects (102) and/or tracking a trajectory of the objects (102) when the objects (102) are passing though the inspection zone (104a, 104b).
Item 15. The inspection system (1) according to anyone of the preceding items, wherein each one of said at least one detector (2) is configured to detect electromagnetic radiation selected from the group comprising UV, visible light and NIR or a combination thereof.
Item 16. The inspection system (1) according to anyone of the preceding claims, wherein the inspection system (1) comprises at least one irradiation arrangement adapted to emit optical radiation towards the inspection area and/or said object (102), preferably by said optical radiation being reflected by said scanning element (136), wherein said at least one irradiation arrangement preferably comprises an illumination source selected from the group comprising LEDs, halogen lamps and/or lasers.
Item 17. The inspection system (1) according to anyone of the preceding claims, wherein said elongated inspection zones comprises at least two elongated inspection zones which are overlapping, and/or directly adjacent, and/or separated by a distance.
Item 18. The inspection system (1) according to anyone of the preceding claims, wherein the number of elongated inspection zones in said plurality of elongated inspection zones is selected from an interval of 4 to 24, preferably from an interval of 8 to 16.
Item 19. The inspection system (1) according to anyone of the preceding claims, comprising a target calibration arrangement (200) adapted in size and shape to provide a calibration surface (201) provided with a geometric shape and/or pattern, and/or comprising one, two or more spectral calibration zones (137, 138) for enabling repeated calibration of the spectral data of the inspection system (1).
Item 20. A method (S0) for inspecting objects (102) passing through an inspection area (104) by an inspection system (1), which inspection area (104) is divided into a plurality of elongated inspection zones (104a, 104b) having a longitudinal extension, wherein said inspection system (1) comprises a scanning element (136) arranged to rotate around a first rotation axis (R) and comprising a first set of reflective surfaces (136a, 136b) arranged one after another around said first rotation axis (R), the inspection system (1) further comprising at least one detector (2) having a field of view for receiving optical radiation, the method (S0) comprising:
   a step (S1) of receiving, by the at least one detector (2), optical radiation originating from an object (102) arranged in at least one of said first number of inspection zones (104a, 104b);
   a step (S2) of rotating the scanning element (136) such that each one of said surfaces (136a, 136b) redirects the field of view of said detector (2) to a different one of said first number of elongated inspection zones (104a, 104b) and such that each one of said surfaces (136a, 136b) redirects the field of view along the extension of the respective elongated inspection zone (104a, 104b).
Item 21. The method (S0) according to claim 20, wherein the method (S0) further comprising
   a step (S3) of transporting the objects (102) though said inspection area (104) in a direction transverse or substantially parallel to the longitudinal extension of the inspection zones (104a, 104b), and
   a step (S4) of rotating the objects (102) when the objects (102) are transported though said inspection area (104).
Item 22. The method (S0) according to anyone of claims 20-21, wherein the method (S0) comprises:
   a step (S5) of measuring spectral characteristics of the objects (102) passing through the inspection zone (104a, 104b).
Item 23. The method (S0) according to claims 21 and 22, wherein the method (S0) comprises:
   a step (S6) of measuring spectral characteristics of the objects (102) passing through the inspection zone (104a, 104b) at different sides of the objects (102) and preferably
   a step (S7) of creating a 360° spectral representation of the object (102).
Item 24. An inspection system (1) for inspecting objects (102) passing through an inspection area (104), wherein said inspection system is configured for passing said objects through said inspection area in a main transportation direction (T) which inspection area (104) is divided into a plurality of elongated inspection zones (104a, 104b) having a longitudinal extension, the inspection system (1) comprising:
   a detector system with at least one detector (2) and an optical arrangement for receiving optical radiation originating from an object (102) arranged in at least one of said plurality of inspection zones (104a, 104b) and redirecting said optical radiation towards said at least one detector (2), and providing said at least one detector (2) with a respective field of view;
   a first scanning element (236) configured to rotate around a first rotation axis (C) which is orthogonal or substantially orthogonal to said main transportation direction, and which scanning element comprises one reflective surface (237),
   wherein the first rotational axis (C) is arranged such that said reflective surface (237) of said first scanning element (236) redirects the field of view of said at least one detector (2) to a respective one of said plurality of elongated inspection zones (104a, 104b) upon a rotation of said first scanning element (236).
25. An inspection system (1) according to claim 24, further comprising a second scanning element (246) configured to rotate around a second rotation axis (R) and comprising at least one reflective surface, wherein the second rotational axis (R) is arranged such that said reflective surface of said second scanning element redirects the field of view of said at least one detector (2) along the longitudinal extension of the respective elongated inspection zone (104a, 104b) upon a rotation of said second scanning element (246).
Item 26. An inspection system (1) according to claim 25, wherein said second scanning element (246) is a polygon mirror.

1. An inspection system for inspecting objects passing through an inspection area, which inspection area is divided into a plurality of elongated inspection zones having a longitudinal extension, the inspection system comprising:
a detector system with at least one detector and an optical arrangement for receiving optical radiation originating from an object arranged in at least one of said plurality of inspection zones and redirecting said optical radiation towards said at least one detector, and providing said at least one detector with a respective field of view;
a scanning element configured to rotate around a first rotation axis and comprising:
a plurality of reflective surfaces arranged one after another around said first rotation axis, which plurality of reflective surfaces comprises a set of reflective surfaces,
wherein each one of said reflective surfaces is adapted in size, shape and orientation to redirect the field of view of said at least one detector to each one of said plurality of elongated inspection zones once per revolution of said scanning element, and each one of said reflective surfaces are configured to redirect the field of view of said at least one detector to and along a respective one of said plurality of elongated inspection zones once per revolution of said scanning element.

2. The inspection system according to claim 1, further comprising rotating means adapted in size and shape for providing a rotation to the objects so the objects are rotating when passing through the inspection area, wherein said rotating means is preferably selected from a group of rotating means comprising moving belts, rotatable wheels, rotatable rollers, rotatable platforms or the like, wherein said rotating means is preferably provided by a conveyor system.

3. The inspection system according to claim 1, wherein the inspection system further comprises a conveyor being provided with a set of compartments or supporting means, wherein each compartment or supporting means is configured for transporting only one object or between 2-10 objects or between 2-50 objects or more objects passed said inspection area; and wherein the each compartment or supporting means is preferably arranged for rotating the objects carried by said compartment or supporting means when passing said inspection area.

4. The inspection system according to claim 1, which inspection system further comprises a conveyor and wherein the inspection area corresponds to a surface of said conveyor, or
which inspection system further comprises a free fall path and wherein the inspection area corresponds to said free fall path.

5. The inspection system according to claim 1, wherein an object and/or a conveyor surface in said inspection area is partially located in different inspection zones.

6. The inspection system according to claim 1, further comprising a conveyor, said conveyor being one of: a conveyor belt and a conveyor being provided with a set of compartments for transporting at least one object passed said inspection area, wherein an object transporting surface of said conveyor extends over at least 3 inspection zones when said object transporting surface is arranged within said inspection area.

7. The inspection system according to claim 6, wherein said object transporting surface extends over at least 60% or over at least 75% or over all but two or over all of said inspection zones, when said object transporting surface is arranged within said inspection area.

8. The inspection system according to claim 1, wherein the optical radiation originating from the object is at least one of emitted, reflected and scattered by and/or transmitted through said object.

9. The inspection system according to claim 1, wherein said scanning element has a set of surface normal, wherein each one of said surface normals is a center surface normal of a respective one of said set of reflective surfaces and wherein each one of said surface normals in said set of surface normals has a different inclination angle to said rotation axis compared to the other surface normals (na, nb) in said set of surface normal.

10. The inspection system according to claim 1, wherein each one of said set of reflective surfaces comprises an at least locally flat reflective surface representing a surface area of at least 80% of the whole surface area of said each one of said set of reflective surfaces.

11. The inspection system according to claim 1, wherein the reflective surfaces have substantially the same shape and surface area and
the scanning element optionally comprises an even number of reflective surfaces and wherein each reflective surface has a corresponding reflective surface arranged on the opposite side of said scanning element and wherein the respective surface normal of said reflective surface and the corresponding reflective surface are substantially parallel.

12. The inspection system according to claim 1, wherein said at least one detector system comprises at least one spectrometer for analyzing spectral characteristics of said objects.

13. The inspection system according to claim 12, wherein said inspection system further comprises a processing circuitry configured to execute:
a data collection function configured to collect spectral data associated with spectral characteristics of said objects based on a signal from the spectrometer, which spectral data pertains to said optical radiation originating from said objects when arranged in at least one of said first number of inspection zones,
a data processing function configured to provide an object representation based on said spectral data, and
an outputting function configured to output object information based on said object representation.

14. The inspection system according to claim 1, wherein the inspection system comprises a transportation means, such as a conveyor or a free fall path, configured to transport the objects through the inspection area.

15. The inspection system according to claim 14, wherein said transportation means are configured to provide a rotational movement of said objects and wherein the detector system is configured to establish a 360° spectral representation of the object.

16. The inspection system according to claim 14, wherein said transportation means are configured to transport the objects passing through the inspection area in a direction substantially along the longitudinal extension of said first number of elongated inspection zones and wherein the first rotation axis is arranged transverse to said direction.

17. The inspection system according to claim 14, wherein said transportation means are configured to transport the objects passing through the inspection area in a direction transverse to the longitudinal extension of said first number of elongated inspection zones and wherein the first rotation axis is arranged substantially parallel to said direction.

18. The inspection system according to claim 1, wherein the inspection system comprises a control unit configured to estimate motion of the objects and/or tracking a trajectory of the objects when the objects are passing though the inspection zone.

19. The inspection system according to claim 1, wherein each one of said at least one detector is configured to detect electromagnetic radiation selected from the group comprising UV, visible light and NIR or a combination thereof.

20. The inspection system according to claim 1, wherein the inspection system comprises:
at least one irradiation arrangement adapted to emit optical radiation towards the inspection area and/or said object, preferably by said optical radiation being reflected by said scanning element,
wherein said at least one irradiation arrangement preferably comprises an illumination source selected from the group comprising LEDs, halogen lamps and/or lasers.

21. The inspection system according to claim 1, wherein said elongated inspection zones comprises at least two elongated inspection zones which are overlapping, and/or directly adjacent, and/or separated by a distance.

22. The inspection system according to claim 1, wherein the number of elongated inspection zones in said plurality of elongated inspection zones is selected from an interval of 4 to 24, preferably from an interval of 8 to 16.

23. The inspection system according to claim 1, comprising a target calibration arrangement adapted in size and shape to provide a calibration surface provided with a geometric shape and/or pattern, and/or comprising one, two or more spectral calibration zones for enabling repeated calibration of the spectral data of the inspection system.

24. A method for inspecting objects passing through an inspection area by an inspection system, which inspection area is divided into a plurality of elongated inspection zones having a longitudinal extension, wherein said inspection system comprises at least one detector having a field of view for receiving optical radiation, and a scanning element arranged to rotate around a first rotation axis and comprising a first set of reflective surfaces arranged one after another around said first rotation axis, wherein each reflective surface is adapted in size, shape and orientation to redirect the field of view of said at least one detector to a respective one of said elongated inspection zones once per revolution of said scanning element, the method comprising:
a step of receiving, by the at least one detector, optical radiation originating from an object arranged in at least one of said plurality of inspection zones;
a step of rotating the scanning element such that each one of said reflective surfaces redirects the field of view of said detector to a different one of said plurality of elongated inspection zones and such that each one of said reflective surfaces redirects the field of view along the extension of the respective elongated inspection zone.

25. The method according to claim 24, wherein the method further comprises:
a step of transporting the objects though said inspection area wherein each one of said objects is partially located in different inspection zones.

26. The method according to claim 25, wherein the method further comprises:
a step of transporting the objects though said inspection area in a direction transverse or substantially parallel to the longitudinal extension of the inspection zones,
wherein each object simultaneously extends over at least 3 inspection zones while being transported trough said inspection area.

27. The method according to claim 26, wherein the method further comprises:
a step of transporting the objects through said inspection area in a direction transverse or substantially parallel to the longitudinal extension of the inspection zones by means of a conveyor being provided with a set of compartments each having a capacity of transporting at least one object passed said inspection area, wherein said at least one object when being transported by one of said compartments passed said inspection area extends over at least 3 inspection zones simultaneously.

28. The method according to claim 24, wherein
said-step of transporting the objects though said inspection area in a direction transverse or substantially parallel to the longitudinal extension of the inspection zones, comprises:
a step of rotating the objects when the objects are transported though said inspection area.

29. The method according to claim 20, wherein the method comprises:
a step of measuring spectral characteristics of the objects passing through the inspection zone.

30. The method according to claim 28, wherein the method comprises:
a step of measuring spectral characteristics of the objects passing through the inspection zone at different sides of the objects and preferably a step of creating a 360° spectral representation of the object.
